(19) United States
(12) Patent Application Publication
(10) Pub. No.: US 2019/0215915 A1
(43) Pub. Date: Jul. 11, 2019

(54) Enhanced Consumer Interface for Preparation, Conditioning and Information of Nutritional Substances

(71) Applicant: Iceberg Luxembourg S.A.R.L., Luxembourg (LU)

(72) Inventor: Eugenio Minvielle, Hillsborough, CA (US)

(21) Appl. No.: 16/239,389

(22) Filed: Jan. 3, 2019

Related U.S. Application Data
(60) Provisional application No. 62/614,979, filed on Jan. 8, 2018.

(51) Int. Cl. H05B 6/64; G05B 15/02; A47J 36/32; H05B 6/68; F24C 7/08

(52) U.S. Cl. CPC H05B 6/6435; G05B 15/02; F24C 7/081; H05B 6/687; A47J 36/321

(57) ABSTRACT

Consumer interfaces, systems and methods for preparation, conditioning and information of nutritional substances are provided. Embodiments further relate to preparation and conditioning of nutritional substances in conjunction with the collection, transmission, and use of information regarding a current nutritional, organoleptic, or aesthetic value of the nutritional sub stance.

### CROSS REFERENCE TO RELATED APPLICATIONS

This application claims priority to U.S. Provisional Application No. 62/614,979, filed Jan. 8, 2018, titled ENHANCED CONSUMER INTERFACE FOR PREPARATION, CONDITIONING, AND INFORMATION OF NUTRITIONAL SUBSTANCES the contents of which are incorporated herein by reference.

### FIELD OF THE INVENTION

The present inventions relate to consumer interfaces, systems and methods for the preparation, conditioning and information of nutritional substances. Embodiments of the present invention further relate to preparation and conditioning of nutritional substances in conjunction with the collection, transmission, and use of information regarding a current nutritional, organoleptic, or aesthetic value of the nutritional substance.

### BACKGROUND OF THE INVENTION

Nutritional substances are traditionally grown (plants), raised (animals) or synthesized (synthetic compounds). Additionally, nutritional substances can be found in a wild, non-cultivated form, which can be caught or collected. While the collectors and creators of nutritional substances generally obtain and/or generate information about the source, history, caloric content and/or nutritional content of their products, they generally do not pass such information along to the users of their products. One reason is the nutritional substance industries have tended to act like “silo” industries. Each group in the food and beverage industry: growers, packagers, processors, distributors, retailers, and preparers work separately, and either shares no information, or very little information, between themselves. There is generally no consumer access to, and little traceability of, information regarding the creation and/or origin, preservation, processing, preparation, or consumption of nutritional substances. It would be desirable for such information be available to the consumers of nutritional substances, as well as all participants in the food and beverage industry—the nutritional substance supply system.

While the nutritional substance supply system has endeavored over the last 50 years to increase the caloric content of nutritional substances produced (which has helped reduce starvation in developing countries, but it has also led to the increase in obesity and other problems in developed countries), maintaining, or increasing, the nutritional content of nutritional substances has been a lower priority and is done in a synthetic manner. Caloric content refers to the energy in nutritional substances, commonly measured in calories. The caloric content could be represented as sugars and/or carbohydrates and/or proteins in the nutritional substances. The nutritional content, also referred to herein as nutritional value, of foods and beverages, as used herein, refers to the non-caloric content of these nutritional substances which are beneficial to the organisms which consume these nutritional substances. For example, the nutritional content of a nutritional substance could include vitamins, minerals, and other non-caloric components which are necessary, or at least beneficial, to the organism consuming the nutritional substances.

While there has recently been greater attention by consumer organizations, health organizations and the public to the nutritional content of foods and beverages, the food and beverage industry has been slow in responding to this attention. One reason for this may be that since the food and beverage industry operates as silos of those who create nutritional substances, those who preserve and transport nutritional substances, those who transform nutritional substances, and those who finally prepare and/or condition the nutritional substances for consumption by the consumer, there has been no system wide coordination or management of nutritional content, and no practical way for creators, preservers, transformers, and conditioners to update labeling content for nutritional substances. While each of these silo industries may be able to maintain or increase the nutritional content of the foods and beverages they handle, each silo industry has only limited information and control of the nutritional substances they receive, and the nutritional substances they pass along, and the limited information in their control provides little utility beyond tracking product inventory and predetermined expiration dates.

As consumers better understand their need for nutritional substances with higher nutritional content, they will start demanding that the food and beverage industry offer products which include better nutritional content, and/or at least information regarding nutritional content of such products, as well as information regarding the source, creation and other origin information for the nutritional substance. In fact, consumers are already willing to pay higher prices for better nutritional content. This can be seen at high-end grocery stores which offer organic, minimally processed, fresh, non-adulterated nutritional substances. Further, as societies and governments seek to improve their constituents' health and lower healthcare costs, incentives and/or mandates will be given to the food and beverage industry to track, maintain, and/or improve the nutritional content of nutritional substances they handle. There will be a need, not only within each food and beverage industry silo to maintain or improve the nutritional content of their products, but an industry-wide solution to allow the management of nutritional content across the entire cycle from creation to consumption. In order to manage the nutritional content of nutritional substances across the entire cycle from creation to consumption, the nutritional substance industry will need to identify, track, measure, estimate, preserve, transport, transform, condition, and record nutritional content for nutritional substances. Of particular importance is the measurement, estimation, and tracking of changes to the nutritional content of a nutritional substance from creation to consumption. This information could be used, not only by the consumer in selecting particular nutritional substances to consume, but it could also be used by the other food and beverage industry sectors, including creation, preservation, transformation, and conditioning, to make decisions on how to create, handle, transport and process nutritional substances. Additionally, those who sell nutritional substances to consumers, such as restaurants and grocery stores, could communicate perceived qualitative values of the nutritional substance in their efforts to market and position their nutritional substance products. Further, a determinant of price of a given nutritional substance could be particular nutritional, organoleptic, or aesthetic values, and if changes to those values are perceived as desirable. For example, if a desirable value has been maintained, improved, or minimally degraded, it could be marketed as a premium product. Still further, a system allowing creators, preservers, transformers, and conditioners of nutritional substances to update labeling content to reflect the most current information about the nutritional substance would provide consumers with the information they need to make informed decisions regarding the nutritional substances they purchase and consume. Such information updates could include nutritional, organoleptic, or aesthetic values of the nutritional substance, and may further include information regarding the source, creation and other origin information for the nutritional substance.

For example, the grower of sweet corn generally provides only basic information as the variety and grade of its corn to the packager, who preserves and transports the corn to a producer to transform the corn for use in a ready-to-eat dinner. The packager may only tell the producer that the corn has been frozen as loose kernels of sweet corn. The producer may only provide the consumer with rudimentary instructions how to cook or reheat the ready-to-eat dinner in a microwave oven, toaster oven or conventional oven, and only tell the consumer that the dinner contains whole kernel corn among the various items in the dinner. Finally, the consumer of the dinner will likely keep her opinions on the quality of the dinner to herself, unless it was an especially bad experience, where she might contact the producer's customer support program to complain. Very minimal, or no information on the nutritional content of the ready-to-eat dinner is passed along to the consumer. The consumer knows essentially nothing about changes (generally a degradation but could be a maintenance or even an improvement) to the nutritional content of the sweet corn from creation, processing, packaging, cooking, preservation, preparation by consumer, and finally consumption by the consumer. The consumer is even more unlikely to be aware of possible changes to labeling content that a creator, preserver, transformer, or conditioner may just have become be aware of, such as changes in information about nutritional, organoleptic, or aesthetic values of the nutritional substance or changes in information regarding the source, creation and other origin information about the nutritional substance. If communicated, such changes to labeling content could affect a purchasing preference or consumption preference of a consumer. Further, if communicated, such changes to labeling content could affect the health, safety, and wellbeing of the consumer. It is also clear that such changes would best be communicated rapidly and by a means readily utilized by a consumer.

Consumers' needs are changing as consumers are demanding healthier foods, such as “organic foods.” Consumers are also asking for more information about the nutritional substances they consume, such as specific characteristics' relating not only to nutritional content, but to allergens or digestive intolerances. For example, nutritional substances which contain lactose, gluten, nuts, dyes, etc. need to be avoided by certain consumers. However, the producer of the ready-to-eat dinner, in the prior example, has very little information to share other than possibly the source of the elements of the ready-to-eat dinner and its processing steps in preparing the dinner. Generally, the producer of the ready-to-eat dinner does not know the nutritional content and organoleptic state and aesthetic condition of the product after it has been reheated or cooked by the consumer, cannot predict changes to these properties, and cannot inform a consumer of this information to enable the consumer to better meet their needs. For example, the consumer may want to know what proportion of desired organoleptic properties or values, desired nutritional content or values, or desired aesthetic properties or values of the corn in the ready-to-eat dinner remain after cooking or reheating, and the change in the desired nutritional content or values, the desired organoleptic properties or values, or the desired aesthetic properties or values (usually a degradation, but could be a maintenance or even improvement). There is a need to preserve, measure, estimate, store and/or transmit information regarding such nutritional, organoleptic, and aesthetic values, including changes to these values, throughout the nutritional substance supply system. Given the opportunity and a system capable of receiving and processing real time consumer feedback and updates regarding changes in the nutritional, organoleptic, and/or aesthetic value of nutritional substances, consumers can even play a role in updating dynamic information about the nutritional substances they have purchased and/or prepared for consumption, such that the information is available and useful to others in the nutritional substance supply system. Ideally, equipment for local storage of nutritional substances by consumers, such as any food preparation appliance, storage location, portable container, tray, bag, and so forth, could interact with nutritional substance products to provide such consumer feedback and updates. Ideally, equipment for conditioning of nutritional substances by consumers, such as any food preparation appliance, oven, toaster, blender, stove top, grill, microwave, and so forth, could interact with nutritional substance products to provide such consumer feedback and updates. Further, equipment for local storage of medicament products by consumers, such as any medicine cabinet, storage location, portable container, tray, bag, and so forth, could interact with the medicament product to provide such consumer feedback and updates.

The caloric and nutritional content information for a prepared food that is provided to the consumer is often minimal. For example, when sugar is listed in the ingredient list, the consumer generally does receive any information about the source of the sugar, which can come from a variety of plants, such as sugarcane, beets, or corn, which will affect its nutritional content. Conversely, some nutritional information that is provided to consumers is so detailed, the consumer can do little with it. For example, this this of ingredients is from a nutritional label on a consumer product: Vitamins—A 355 IU 7%, E 0.8 mg 4%, K 0.5 mcg, 1%, Thiamin 0.6 mg 43%, Riboflavin 0.3 mg 20%, Niacin 6.0 mg 30%, B6 1.0 mg 52%, Foliate 31.5 mcg 8%, Pantothenic 7%; Minerals Calcium 11.6 1%, Iron 4.5 mg 25%, Phosphorus 349 mg 35%, Potassium 476 mg 14%, Sodium 58.1 mg 2%, Zinc 3.7 mg 24%, Copper 0.5 mg 26%, Manganese 0.8 mg 40%, Selenium 25.7 mcg 37%; Carbohydrate 123 g, Dietary fiber 12.1 g, Saturated fat 7.9 g, Monosaturated Fat 2.1 g, Polysaturated Fat 3.6 g, Omega 3 fatty acids 108 g, Omega 6 fatty acids 3481, Ash 2.0 g and Water 17.2 g. (%=Daily Value). There is a need to provide information about nutritional substances in a meaningful manner. Such information needs to be presented in a manner that meets the specific needs of a particular consumer. For example, consumers with a medical condition, such as diabetes, would want to track specific information regarding nutritional values associated with sugar and other nutrients in the foods and beverages they consume, and would benefit further from knowing changes in these values or having tools to quickly indicate or estimate these changes in a retrospective, current, or prospective fashion, and even tools to report these changes, or impressions of these changes, in a real-time fashion. Consumers would want to track medicaments for specific requirements, changes in their medicinal values, degradation, and for potential interactions with other medicaments and nutritional substances they are consuming or planning to consume.

In fact, each silo in the food and beverage industry already creates and tracks some information, including caloric and nutritional information, about their product internally. For example, the farmer who grew the corn knows the variety of the seed, condition of the soil, the source of the water, the fertilizers and pesticides used, and can measure the caloric and nutritional content at creation. The packager of the corn knows when it was picked, how it was transported to the packaging plant, how the corn was preserved and packaged before being sent to the ready-to-eat dinner producer, when it was delivered to the producer, and what degradation to caloric and nutritional content has occurred. The producer knows the source of each element of the ready-to-eat dinner, how it was processed, including the recipe followed, and how it was preserved and packaged for the consumer. Not only does such a producer know what degradation to caloric and nutritional content occurred, the producer can modify its processing and post-processing preservation to minimally affect nutritional content. The preparation of the nutritional substance for consumption can also degrade the nutritional content of nutritional substances. Finally, the consumer knows how she prepared the dinner, what condiments were added, and whether she did or did not enjoy it.

If there was a mechanism to share this information, the quality of the nutritional substances, including caloric and nutritional, organoleptic, and aesthetic value, could be preserved and improved. Consumers could be better informed about nutritional substances they select and consume, including the state, and changes in the state, of the nutritional substance throughout its lifecycle from creation to consumption. The efficiency and cost effectiveness of nutritional substances could also be improved. Feedback within the entire chain from creator to consumer could provide a closed-loop system that could improve quality (taste, appearance, and caloric and nutritional content), efficiency, value and profit. For example, in the milk supply chain, at least 10% of the milk produced is wasted due to safety margins included in product expiration dates. The use of more accurate tracking information, measured quality (including nutritional content) information, and historical environmental information could substantially reduce such waste. Collecting, preserving, measuring and/or tracking information about a nutritional substance in the nutritional substance supply system, would allow needed accountability. There would be nothing to hide.

As consumers are demanding more information about what they consume, they are asking for products that have higher nutritional content and more closely match good nutritional requirements, and would like nutritional products to actually meet their specific nutritional requirements. While grocery stores, restaurants, and all those who process and sell food and beverages may obtain some information from current nutritional substance tracking systems, such as labels, these current systems can provide only limited information.

Current packaging materials for nutritional substances include plastics, paper, cardboard, glass, and synthetic materials. Generally, the packaging material is chosen by the producer to best preserve the quality of the nutritional substance until used by the customer. In some cases, the packaging may include some information regarding type of nutritional substance, identity of the producer, and the country of origin. Such packaging generally does not transmit source information of the nutritional substance, such as creation information, current or historic information as to the external conditions of the packaged nutritional substance, or current or historic information as to the internal conditions of the packaged nutritional substance.

Traditional food processors take nutritional substances from producers and transform them into nutritional substances for consumption by consumers. While they have some knowledge of the nutritional substances they purchase, and make such selections to meet the needs of the consumers, they generally do not transmit that information along to consumers, nor change the way they transform the nutritional substances based on the history or current condition of the nutritional substances they receive for transformation.

Consumers of nutritional substances are sometimes given options on how to prepare nutritional substances they have obtained from the store, such as different cooking devices: microwave ovens, conventional ovens, etc., and/or limited taste preferences such as crunchy or soft. However, if the consumer desires to prepare a specific recipe, they must obtain all the proper ingredients themselves, as well as prepare the recipe themselves including which cooking appliances need to be used. Further, the consumer has no way of knowing the history or current condition of the nutritional substances they obtain for preparing a desired recipe. Still further, the consumer has no way of knowing how to change or modify the conditioning process to achieve desired nutritional, organoleptic, and aesthetic properties after preparation. Consumers locally store, condition, and consume nutritional substances they acquire, but have no way to change the way they locally store, condition, and consume the nutritional substances based on the history or current condition of the nutritional substances.

An important issue in the creation, preservation, transformation, conditioning, and consumption of nutritional substances are the changes that occur in nutritional substances due to a variety of internal and external factors. Because nutritional substances are composed of biological, organic, and/or chemical compounds, they are generally subject to degradation. This degradation generally reduces the nutritional, organoleptic, and/or aesthetic values of nutritional substances. While not always true, nutritional substances are best consumed at their point of creation. However, being able to consume nutritional substances at the farm, at the slaughterhouse, at the fishery, or at the food processing plant is at least inconvenient, if not impossible. Currently, the food and beverage industry attempts to minimize the loss of nutritional, organoleptic, and/or aesthetic value, often through the use of additives or preservatives and often through freezing the nutritional substance, and/or attempts to hide this loss of nutritional, organoleptic, and/or aesthetic value from consumers. Consumers are left are provided with virtually no tools to help them in their attempts to determine and minimize the loss of nutritional, organoleptic, and/or aesthetic value of the nutritional substances they acquire, locally store, condition, and consume.

As consumers demand more information regarding the nutritional substances they consume and prepare, the traditional ways in engaging and interacting with the consumer, and the consumer experience itself, is changing.

There are a significant number of conventional conditioning programs available in printed and digital media for food preparers and consumers. In digital form, conditioning programs can be shared through social media. These conditioning programs are rigid; they provide a static list of nutritional substances (e.g. food items or ingredients), methods, accessories, and a single of specific instructions for preparing a particular meal or dish. These traditional conditioning programs rarely propose alternatives. For example, a meal preparer is left without alternate ingredient options when a preferred accessory or ingredient is unavailable to him/her.

Conventional meal preparation instructions also have no flexibility for alternate options in the preparation steps. Conditioning instructions can prescribe the preparation of the ingredients (slicing, mushing, peeling, among other actions) and conditioning parameters (such as time, temperature and a conditioning mode). If a specific conditioning mode is not available in the conditioner, the food preparer is left guessing as to what other mode available on the conditioner can be used in lieu of the prescribed mode. Conventional conditioning modes often include bake, roast, and grill, while some high-end conditioners feature special conditioning modes that are unavailable in other conditioners (e.g. steam or convection microwave plus broil). These special conditioning modes cannot be used with lower-end conditioning programs, as the parameters for these special modes are not prescribed.

Moreover, traditional conditioning programs do not allow the consumers to personalize meals based on their preferences food allergies or intolerances. They do not take into account the state of the food nor give instructions as to how best leverage the ingredients the meal preparer has on hand. The nutritional value and food allergen information of these static conditioning programs is fixed, that is, if the publisher of the conditioning program recommends a replacement of an ingredient and the food preparers replace the ingredient, the new nutritional value or potential food allergens are not communicated. This new information can have implications on the health of the actual consumer of the meal.

Some have tried to address this issue. For example, Shahar (U.S. Pat. No. 9,754,508) describe a method and system for analyzing and processing an analog or digital food recipe and transforming it into a machine-readable recipes. This machine readable conditioning protocol allows the user to scale the recipe and provides a nutritional information and a dietary analysis. However, the ingredient substitutions are up to the user and they have to be entered manually in the Recipe Analyzer Program, along with the modified instructions. Thus, the system is quite limited and does not provide the flexibility and adaptability consumers need and want. Moreover, the system provides limited consumer interface and interaction.

In addition, creating digital content (video, audio or text) for every conditioning protocol is time consuming and expensive. For instance, in order to generate one hundred digital conditioning protocols, conventional conditioning methods require the production of one hundred sets of unique videos, ingredient list and instructions. In addition, if appliance manufacturers or FMCG would like to have one or several of these conditioning protocols tailored made for their brand, it will be required to generate a new set of conditioning protocols and digital media due to their static and inflexible design.

Furthermore, the inflexibility of the traditional conditioning protocols does not allow a variable calculation of a meal preparation time depending of the skill of the food preparer. Rather, conventional time estimates are high-level estimates as based on assumptions about an average food preparer made by the conditioning program.

Therefore, when food preparers who lack culinary experience are generally unknowledgeable about viable substitutions and variations in preparation and conditioning methods for any given meal; these food preparers are forced to provide the ingredients and accessories dictated by the recipe and follow the preparation methods dictated by the conditioning program. Altogether, traditional conditioning programs, in general, do not consider (1) a consumer's allergies and health conditions, (2) preferential ingredient substitutions, (3) differences among various brands and models of conditioners, or (4) conditioning skills of a meal preparer.

These flaws in conventional conditioning programs result in fewer consumers preparing or eating meals at home; this can have the effect of less time with family at the table. As an analogy with automobile guidance systems, this type of conditioning programs takes the user to a destination using one inflexible route (just like a paper map), rather than describing a journey. Accordingly, a significant new way of addressing these limitations is needed.

Of particular limitation, there currently exists no fully integrated solution which allows consumers to interface and interact with content, customizable conditioning programs, execution or actuation of the conditioning program in an appliance, to seamlessly prepare a meal. Accordingly, significant developments and improvements are needed.

Overall, the examples herein of some prior or related systems and their associated limitations are intended to be illustrative and not exclusive. Other limitations of existing or prior systems will become apparent to those of skill in the art upon reading the following Detailed Description.

### OBJECTS OF THE INVENTION

It is an object of the present invention to track changes of nutritional, organoleptic, and/or aesthetic values of a nutritional substance, and to minimize and/or track degradation of said values, and collect, store, and transmit information regarding these changes or degradation, and information related to origin and creation of the nutritional substance, from creation through consumption, including all phases of preservation, transformation, local storage and conditioning.

It is an object of the present invention to provide appliances and equipment to track changes of nutritional, organoleptic, and/or aesthetic values of a nutritional substance, and to minimize and/or track degradation of said values, and/or collect, store, and/or transmit information regarding these changes or degradation, and information related to origin and creation of the nutritional substance, during the local storage and conditioning of the nutritional sub stance.

It is an object of the present invention to modify or adapt the local storage and conditioning of a nutritional substance to maintain and/or minimize degradation of and/or improve nutritional, organoleptic, and/or aesthetic values of the nutritional substance.

It is an object of the present invention that information related to changes or degradation of nutritional, organoleptic, and/or aesthetic values, including current nutritional, organoleptic, and/or aesthetic values, or information related to the origin and creation of a nutritional substance, can be utilized during local storage and conditioning of the nutritional substance to confirm compliance, or non-compliance, with general consumer requirements, or with a specific consumer's requirements, regarding nutritional, organoleptic, and/or aesthetic values, or regarding origin and creation of the nutritional substance.

It is an object of the present invention that information related to changes or degradation of nutritional, organoleptic, and/or aesthetic values, including current nutritional, organoleptic, and/or aesthetic values, can be used to adaptively condition the nutritional substance so as to maintain and/or minimize degradation of and/or improve nutritional, organoleptic, or aesthetic values of the adaptively conditioned nutritional substance.

It is an object of the present invention that information collected by sensors of, or sensors communicating with, a conditioning appliance can collect all types of physical attribute data by sensing a nutritional substance, and that the nutritional substance can be identified and its current nutritional, organoleptic, and aesthetic state determined, by comparing the sensed data to a library of data for known nutritional substances at known nutritional, organoleptic, and aesthetic states, and further that the nutritional substance can be adaptively conditioned responsive to: its current nutritional, organoleptic, and aesthetic state; and consumer input received through a consumer interface of the conditioning appliance.

It is an object of the present invention to provide an enhanced system and method and integrated consumer experience, where consumers interface and interact with content, customizable conditioning programs, execution or actuation of the conditioning program in an appliance, to prepare a meal.

It is a further object of the present invention to provide a hand's free and/or voice activated conditioning system and method.

### SUMMARY OF THE INVENTION

In an embodiment of the present invention, a system is provided for the tracking of changes of nutritional, organoleptic, and/or aesthetic values of a nutritional substance, wherein the system may collect, store, and transmit information regarding the changes of nutritional, organoleptic, and/or aesthetic values of the nutritional substance, and information related to origin and creation of the nutritional substance, from creation through consumption, including all phases of preservation, transformation, local storage and conditioning.

In an embodiment of the present invention, a system is provided for the tracking of changes of nutritional, organoleptic, and/or aesthetic values of a nutritional substance, wherein the system may collect, store, and transmit information regarding the changes of nutritional, organoleptic, and/or aesthetic values of the nutritional substance, and information related to origin and creation of the nutritional substance, during local storage and conditioning of the nutritional substance.

In an embodiment of the present invention, local storage appliances and equipment are provided to track changes of nutritional, organoleptic, and/or aesthetic values of a nutritional substance, and to minimize and/or track degradation of said values, and/or collect, store, and/or transmit information regarding these changes or degradation, and information related to origin and creation of the nutritional substance, during the local storage of the nutritional substance prior to conditioning or consumption of the nutritional substance.

In an embodiment of the present invention, local storage and conditioning of a nutritional substance is modified or adapted to maintain and/or minimize degradation of and/or improve nutritional, organoleptic, and/or aesthetic values of the nutritional substance.

In an embodiment of the present invention, during local storage or conditioning of a nutritional substance, information related to changes or degradation of nutritional, organoleptic, and/or aesthetic values, including current nutritional, organoleptic, and/or aesthetic values, or information related to the origin and creation of the nutritional substance, is compared with general consumer requirements, or with a specific consumer's requirements, to confirm compliance, or non-compliance, regarding nutritional, organoleptic, and/or aesthetic values, or regarding origin and creation of the nutritional substance.

In an embodiment of the present invention, information related to changes or degradation of nutritional, organoleptic, and/or aesthetic values, including current nutritional, organoleptic, and/or aesthetic values, is used to determine adaptive conditioning parameters responsive to said changes or degradation or current values, to adaptively condition the nutritional substance so as to maintain and/or minimize degradation of and/or improve nutritional, organoleptic, or aesthetic values of the adaptively conditioned nutritional substance.

In an embodiment of the present invention, sensors of, or sensors communicating with, a conditioning appliance can collect all types of nutritional substance physical attribute data by sensing a nutritional substance, whereby the nutritional substance is identified and its current nutritional, organoleptic, and aesthetic state determined, by comparing the sensed data to a library of physical attribute data for known nutritional substances at known nutritional, organoleptic, and aesthetic states, and the conditioning appliance further adaptively conditions the nutritional substance responsive to: its current nutritional, organoleptic, and aesthetic state; and consumer input received through a consumer interface of the conditioning appliance.

In an embodiment of the present invention information regarding a change of nutritional, organoleptic, and/or aesthetic value of nutritional substances, collectively and individually referred to herein as ΔN, is: measured or collected or calculated or created or estimated or indicated or determined in any suitable manner; stored and/or tracked and/or transmitted and/or processed prior to transformation and/or following transformation, during preservation, and during local storage and conditioning, such that the degradation of specific nutritional, organoleptic, and/or aesthetic values can be minimized and specific residual nutritional, organoleptic, and/or aesthetic value can be optimized. A change of nutritional, organoleptic, and/or aesthetic value may not occur, in which case ΔN would be zero. The change of nutritional, organoleptic, and/or aesthetic value may be a degradation, in which case ΔN would be negative. The change of nutritional, organoleptic, and/or aesthetic value may be an improvement, in which case ΔN would be positive.

In an embodiment of the present invention, a system is provided for the creation, collection, storage, transmission, and/or processing of information regarding nutritional substances so as to improve, maintain, or minimize degradation of nutritional, organoleptic, and/or aesthetic value of nutritional substances. Additionally, the present invention provides such information for use by the creators, preservers, transformers, conditioners, and consumers of nutritional substances. The nutritional information creation, preservation, and transmission system of the present invention should allow the nutritional substance supply system to improve its ability to minimize degradation of nutritional, organoleptic and/or aesthetic value of the nutritional substance, and/or inform the consumer about such degradation. The ultimate goal of the nutritional substance supply system is to minimize degradation of nutritional, organoleptic and/or aesthetic values, or as it relates to ΔN, minimize the negative magnitude of ΔN. However, an interim goal should be providing consumers with significant information regarding any change, particularly degradation, of nutritional, organoleptic and/or aesthetic values of nutritional substances consumers select, locally store, condition, and consume, the ΔN, such that desired information regarding specific residual nutritional, organoleptic, and/or aesthetic values can be ascertained using the ΔN. Entities within the nutritional substance supply system who provide such ΔN information regarding nutritional substances, particularly regarding degradation, will be able to differentiate their products from those who obscure and/or hide such information. Entities within the nutritional substance supply system who provide local storage environments, local storage containers, and conditioning appliances enabling the tracking and use of ΔN information will be able to differentiate their products from those that do not track and utilize ΔN information. Additionally, such entities should be able to charge a premium for products which either maintain their nutritional, organoleptic, and/or aesthetic value, or supply more complete information about changes in their nutritional, organoleptic, and/or aesthetic value, the ΔN.

In an embodiment of the present invention, a system is provided for hands free consumer interface with a mobile device application (sometimes referred to as an “app”) with instructions to prepare and condition nutritional substances. The hands-free interface allows the consumer to provide meal inputs, and navigate between conditioning steps on the mobile device display, whereby each step includes content in forms including, but not limited to, text, image, or video instructions. Hands-free commands can be in the form of voice, gesture, eye movement, brain waves or any other means of human to computer navigation, that for example eliminates the need of touch to interact with the consumer interface or conditioning program. The hands-free operation can send commands to execute both traditional conditioning instructions and sensor based adaptive conditioning instructions, which are sent to a connected conditioner and modified based on conditioning variables of both the conditioner and the nutritional substance being conditioned.

For example in one embodiment, a conditioning system for preparation and conditioning of nutritional substances is provided comprising: a microphone configured to output a set of audio data representative of a user's voice; at least two types of conditioners; a memory containing machine readable medium comprising machine executable code having stored thereon instructions; a control system coupled to the memory comprising one or more processors, the control system configured to execute the machine executable code to cause the control system to: process the set of audio data to output a set of verbal instructions; process the set of verbal instructions to determine a nutritional substance and a conditioning type; identify a matching conditioner based on the conditioning type of the at least two types of conditioners; retrieve a matching conditioning protocol based on the matching conditioner from a database of conditioning protocols referenced to nutritional substances and different types of conditioners; and send instructions to the matching conditioner to initiate conditioning of the nutritional substance with the matching conditioning protocol.

In another example, a conditioning system for preparation and conditioning of nutritional substances is provided comprising: a microphone configured to output audio data representative of a user's voice; at least one conditioner; a memory containing machine readable medium comprising machine executable code having stored thereon instructions; a control system coupled to the memory comprising one or more processors, the control system configured to execute the machine executable code to cause the control system to: process a first set of audio data output from the microphone to output a set of verbal instructions; process the set of verbal instructions to determine a nutritional substance; retrieve a set of conditioning protocols based on the at least one conditioner and the nutritional substance from a database of conditioning protocols referenced to nutritional substances and different types of conditioners; process a second set of audio data output from the microphone to output a confirmation of a user's selected conditioning protocol of the retrieved set of conditioning protocols; execute the selected conditioning protocol; and send instructions to the conditioner in real time during execution of the selected conditioning protocol to condition the nutritional substance.

In yet a further example, a conditioning system for preparation and conditioning of nutritional substances is provided comprising: a user interface; at least two conditioners; a server in communication with the least one conditioner over a network connection; a memory containing machine readable medium comprising machine executable code having stored thereon instructions; a control system coupled to the memory comprising one or more processors, the control system configured to execute the machine executable code to cause the control system to: determine by the server, a selected conditioner of the at least two conditioners and a selected nutritional substance based on a first set of data received from the user interface; retrieve, by a server from a database, a set of conditioning protocols based on the selected conditioner and the selected nutritional substance from a database of conditioning protocols referenced to nutritional substances and different types of conditioners; determine, by the server, a selected conditioning protocol of the retrieved set of conditioning protocols based on a second set of data received from the user interface; initiate, by the server, a first step of the selected conditioning protocol by sending a first set of real time instructions to set parameters on the selected conditioner during conditioning for a first phase over the network; and determine, by the server, when a duration of the first step has expired and send a second set of real time instructions to set parameters on the selected conditioner for a second phase over the network.

Other advantages and features will become apparent from the following description and claims. It should be understood that the description and specific examples are intended for purposes of illustration only and not intended to limit the scope of the present disclosure.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows a schematic functional block diagram of a nutritional substance supply system relating to the present invention.

FIG. 2 shows a graph representing a value of a nutritional substance which changes according to a change of condition for the nutritional substance.

FIG. 3 shows a schematic functional block diagram of a transformation module according to the present invention.

FIG. 4 shows a schematic functional block diagram of a conditioning module according to the present invention.

FIG. 5 shows a schematic functional block diagram of a conditioning module according to the present invention.

FIG. 6 shows a graph representing a value of a nutritional substance which changes according to changes in multiple conditions for the nutritional substance.

FIG. 7 shows a graph representing a value of a nutritional substance which changes according to changes in multiple conditions for the nutritional substance.

FIG. 8 shows a schematic functional block diagram of a conditioning module according to the present invention.

FIG. 9 shows a schematic diagram illustrating an integrated system architecture for a hands-free (voice, audio, gesture) conditioning system comprised of voice input interface, screen input interface, and conditioner, connected to one or more cloud services which may intercommunicate, according to embodiments of the present invention.

FIG. 10 shows a schematic diagram of the integrated system and depicting an example of hands-free control of a conditioner through an app using voice, according to embodiments of the present invention.

FIG. 11 illustrates another hands-free example, using voice navigation of a conditioning program with an app (content: text), according to embodiments of the present invention.

FIGS. 12A-12C illustrate another hands-free example, using voice navigation of a conditioning program with an app (content: video), according to embodiments of the present invention.

FIG. 13 illustrates a flow chart diagram illustrating an example of a method according to embodiments of the present invention.

FIG. 14 illustrates a flow chart diagram illustrating an example of a method according to embodiments of the present invention.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The following discussion provides a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “controller,” “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In some instances, the interconnection between modules is the internet, allowing the modules (with, for example, WiFi capability) to access web content offered through various web servers. The network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

The modules in the systems can be understood to be integrated in some instances and in particular embodiments, only particular modules may be interconnected.

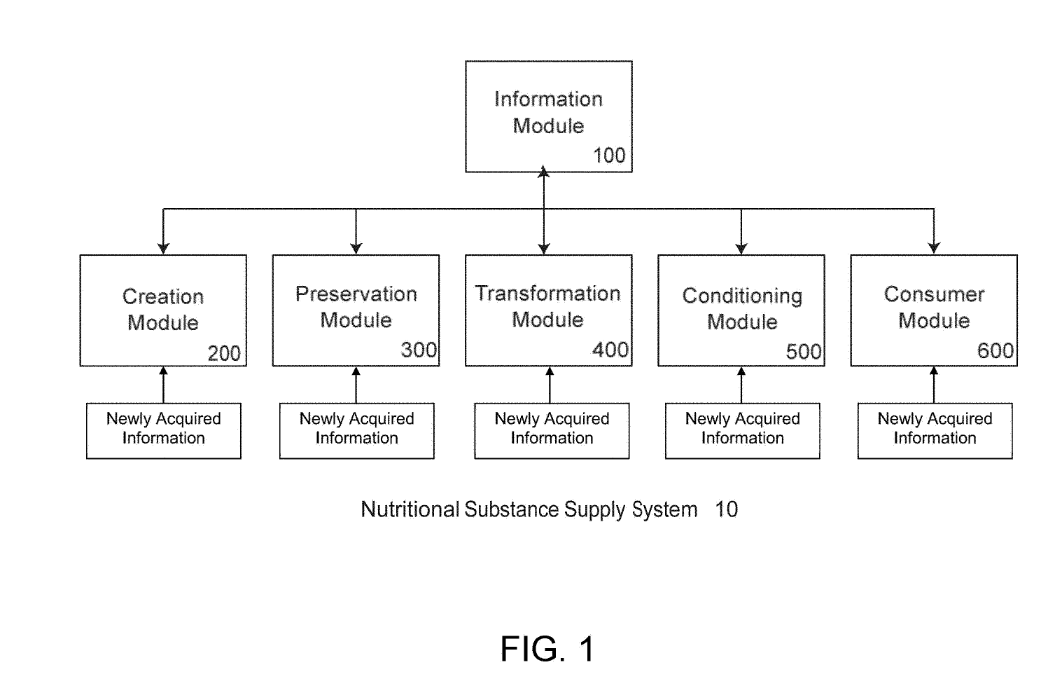

FIG. 1 shows the components of a nutritional substance industry 10. It should be understood that this could be the food and beverage ecosystem for human consumption, but could also be the feed industry for animal consumption, such as the pet food industry. A goal of the present invention for nutritional substance industry 10 is to create, preserve, transform and trace the change in nutritional, organoleptic and/or aesthetic values of nutritional substances, collectively and individually also referred to herein as ΔN, through their creation, preservation, transformation, conditioning and consumption. While the nutritional substance industry 10 can be composed of many companies or businesses, it can also be integrated into combinations of business serving many roles, or can be one business or even individual. Since ΔN is a measure of the change in a value of a nutritional substance, knowledge of a prior value (or state) of a nutritional substance and the ΔN value will provide knowledge of the changed value (or state) of a nutritional substance, and can further provide the ability to estimate a change in value (or state).

Module 200 is the creation module. This can be a system, organization, or individual which creates and/or originates nutritional substances. Examples of this module include a farm which grows produce; a ranch which raises beef; an aquaculture farm for growing shrimp; a factory that synthesizes nutritional compounds; a collector of wild truffles; or a deep sea crab trawler.

Preservation module 300, described in co-pending application U.S. Ser. No. 13/888,353, titled “Preservation System for Nutritional Substances”, and incorporated in its entirety by reference herein, is a preservation system for storing, preserving and protecting the nutritional substances created by creation module 200. Once the nutritional substance has been created, generally, it will need to be packaged in some manner for its transition to other modules in the nutritional substances industry 10. While preservation module 300 is shown in a particular position in the nutritional substance industry 10, following the creation module 200, it should be understood that the preservation module 300 actually can be placed anywhere nutritional substances need to be stored and preserved during their transition from creation to consumption. It is understood that a nutritional substance may experience more than one preservation event, and that such preservation events may include the local storage of the nutritional substance, such as by a consumer prior to conditioning or consumption.

A specific aspect of the present invention in achieving its goal related to ΔN information is to provide a system that tracks ΔN information during local storage or local preservation of a nutritional substance by a consumer. It is understood that a nutritional substance may experience more than one preservation event, and that such preservation events may include any known form of local storage or local preservation of a nutritional substance prior to conditioning and/or consumption, hereinafter referred to as local storage. Such local storage may take many forms, such as the storage of refrigerated items in a refrigerator, the storage of frozen items in a freezer, the storage of wine bottles in a wine-rack, the storage of canned or dry goods in a pantry, the storage of bread in a bread drawer, the storage of fruit in a counter top tray, and any other form of local nutritional substance storage known to those skilled in the art. It is understood that the present inventions include the local storage of consumable items such as medicaments, for example, medicaments stored in a refrigerator, medicaments stored in a medicine cabinet, or medicaments stored in any other known fashion.

Local storage according to the present invention can be enabled by local storage environments according to the present invention, such as a refrigerator, drawer, cabinet, portable cooler, and any other type of storage environment, wherein the local storage environment is provided with the same capabilities as the preservation module. In addition; local storage according to the present invention can be enabled by local storage containers according to the present invention, such as storage bags, trays, resealable storage-ware, jars, boxes, bottles, and any other type of storage environment, wherein the local storage container is provided with the same capabilities as the preservation module. In a further embodiment of the present invention, currently known traditional formats of storage environments and storage containers are enabled to provide local storage according to the present invention by being coupled with a coupon, hereinafter referred to as a local storage coupon, wherein the local storage coupon provides a traditional storage environment or traditional storage container with the same capabilities as the preservation module. The local storage coupon can be attachment to, placed within, or in any known fashion coupled with, any known formats of traditional storage environments and traditional storage containers.

Transformation module 400 is a nutritional substance processing system, such as a manufacturer who processes raw materials such as grains into breakfast cereals. Transformation module 400 could also be a ready-to-eat dinner manufacturer who receives the components, or ingredients, also referred to herein as component nutritional substances, for a ready-to-eat dinner from preservation module 300 and prepares them into a frozen dinner. While transformation module 400 is depicted as one module, it will be understood that nutritional substances may be transformed by a number of transformation modules 400 on their path to consumption.

Conditioning module 500 is a consumer preparation system for preparing the nutritional substance immediately before consumption by the consumer. Conditioning module 500 can be a microwave oven, a blender, a toaster, a convection oven, a cook, etc. It can also be systems used by commercial establishments to prepare nutritional substance for consumers such as a restaurant, an espresso maker, pizza oven, and other devices located at businesses which provide nutritional substances to consumers. Such nutritional substances could be for consumption at the business or for the consumer to take out from the business. Conditioning module 500 can also be a combination of any of these devices used to prepare nutritional substances for consumption by consumers.

Consumer module 600 collects information from the living entity which consumes the nutritional substance which has passed through the various modules from creation to consumption. The consumer can be a human being, but could also be an animal, such as pets, zoo animals and livestock, which are they themselves nutritional substances for other consumption chains. Consumers could also be plant life which consumes nutritional substances to grow. Consumer module 600 also includes information on preparation and conditioning instructions of nutritional substances for consumption. In this embodiment, the preparation and conditioning instructions are in digital form, operated via a means of navigation that does not require touching the display of the mobile device that communicates instructions. Such hands free means include but are not limited to voice, gesture, eye movement and brain waves.

The information provided in the consumer module 600 is not restricted to providing digital conditioning instructions and navigation instructions, but also includes accepting consumer input based on nutritional substance preferences (likes and dislikes), diet, allergies and intolerances. The consumer module is also configured to accommodate and account for the desired preparation of the nutritional substance, time and difficulty of preparation, the desired state of the nutritional substance at the end of the conditioning process (for instance, a steak prepared to rare, medium or well done). The consumer module may also include sensor based inputs and outputs, such as temperature of the conditioner and/or the nutritional substance. It also includes consumer feedback regarding the instructions themselves, the end result of the conditioning process and quality of the conditioned nutritional substance, in terms of both organoleptic and food safety,

As for the means of navigation for the conditioning programs or protocols displayed digitally in an app running on a mobile device, there are several modes: touch and hands-free navigation. An example of hands-free navigation could involve a voice assistant, a device made of smart speakers with integrated microphones. There are commercially available devices, with advanced speech recognition capabilities. These devices connect to a voice-controlled intelligent personal assistant service, which responds to a predefined key phrase. These devices are connected to a cloud and are capable of voice interaction, music playback, making to-do lists, setting alarms, streaming podcasts, playing audiobooks, and providing weather, traffic and other real-time information, and the like. Interaction between the voice assistant and the application is made via cloud to cloud communication, whereby the app cloud hosting the conditioning programs and services are linked with those of the voice assistant. In some embodiments, a third cloud (called the “conditioning cloud”) is further integrated if a connected (i.e. WiFi or otherwise internet enabled) conditioning appliance is used to prepare part of the meal. Thus, in some embodiments, the conditioning cloud would be interacting with the app cloud, and the voice cloud is interacting with the app cloud. In this manner, the commands from the user are transmitted from the voice assistant device to the cloud and from the cloud to the application on the mobile device.

Of particular advantage, according to embodiments of the present invention, the user does not have to touch the display on the mobile device, adding significant convenience to the users as they do not need to stop preparation to change content as the preparation and/or conditioning process progresses, which could be to change screens with text or video instructions, or to pause, rewind, skip or resume a video. Moreover, the user profile can be saved in the cloud, which also includes its nutritional substance preferences, allergies, customized recipes, custom conditioning protocols, altitude compensation information based on location (or GPS location of phone) and dislikes for the user, family and friends. The voice assistant, in communication with the app cloud and the mobile device, can warn the user if a recipe or conditioning program has ingredients that are flagged in the user or family profile.

Voice is just one example of hands free navigation, as the use of gestures or monitoring eye movement or brain waves can perform the same function and provide the same benefit to the user following conditioning instructions. Accordingly, throughout this disclosure, the various systems and methods may contain audio or visual sensors to sense the user's voice or the gestures made by the user.

Information module 100 receives and transmits information regarding a nutritional substance between each of the modules in the nutritional substance industry 10 including, the creation module 200, the preservation module 300, the transformation module 400, the conditioning module 500, and the consumer module 600. The nutritional substance information module 100 can be an interconnecting information transmission system which allows the transmission of information between various modules. Information module 100 contains a database, also referred to herein as a dynamic nutritional value database, where the information regarding the nutritional substance resides, particularly ΔN for the nutritional substance. Information module 100 may also contain a massive database of physical attributes of known nutritional substances at known nutritional, organoleptic, and aesthetic states, also referred to herein as nutritional substance attribute library, which can be utilized for determining the identity and current nutritional, organoleptic, and aesthetic state of a nutritional substance. Information module 100 can be connected to the other modules by a variety of communication systems, such as paper, computer networks, the internet and telecommunication systems, such as wireless telecommunication systems. In a system capable of receiving and processing real time consumer feedback and updates regarding changes in the nutritional, organoleptic, and/or aesthetic value of nutritional substances, or ΔN, consumers can even play a role in updating a dynamic nutritional value database with observed or measured information about the nutritional substances they have purchased and/or prepared for consumption, so that the information is available and useful to others in the nutritional substance supply system, such as through reports reflecting the consumer input or through modification of ΔN.

In an embodiment of the present invention, such consumer feedback and updates related to ΔN information are provided during the local storage of a nutritional substance. In a preferred embodiment, such consumer feedback and updates related to ΔN information are obtained through, or provided by, local storage environments, local storage containers, and local storage coupons according to the present invention.

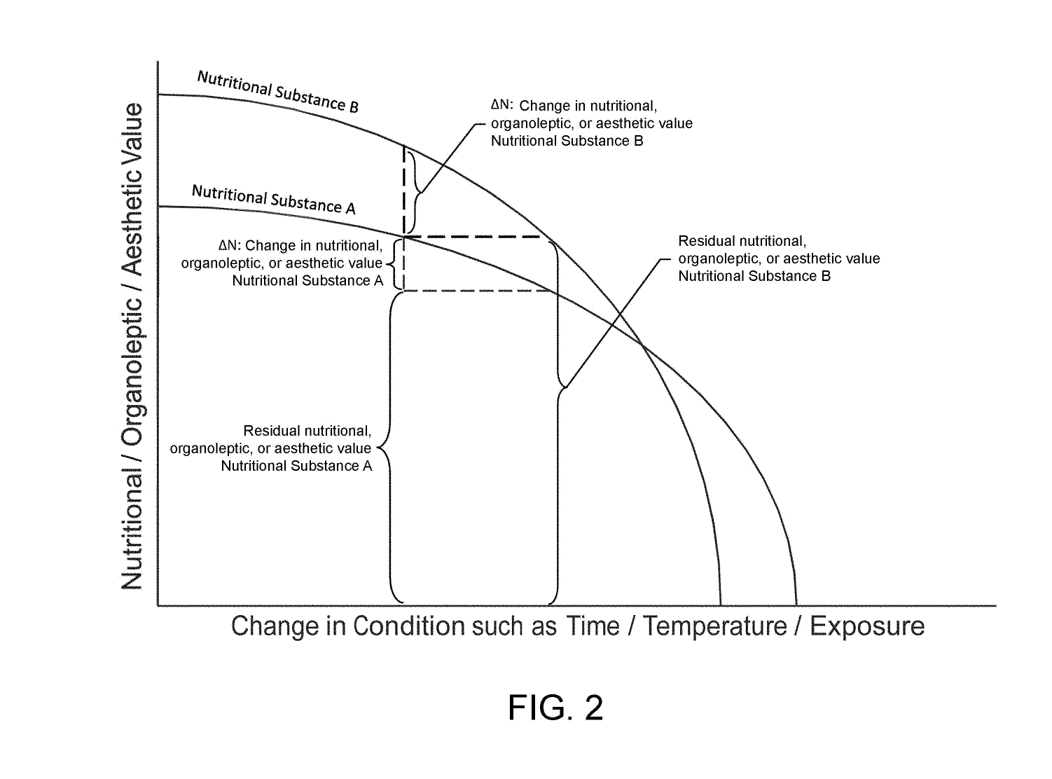

FIG. 2 is a graph showing the function of how a nutritional, organoleptic, or aesthetic value of a nutritional substance varies over the change in a condition of the nutritional substance. Plotted on the vertical axis of this graph can be either the nutritional value, organoleptic value, or even the aesthetic value of a nutritional substance. Plotted on the horizontal axis can be the change in condition of the nutritional substance over a variable such as time, temperature, location, and/or exposure to environmental conditions. This exposure to environmental conditions can include: exposure to air, including the air pressure and partial pressures of oxygen, carbon dioxide, water, or ozone; airborne chemicals, pollutants, allergens, dust, smoke, carcinogens, radioactive isotopes, or combustion byproducts; exposure to moisture; exposure to energy such as mechanical impact, mechanical vibration, irradiation, heat, or sunlight; or exposure to materials such as packaging. The function plotted as nutritional substance A could show a ΔN for milk, such as. the degradation of a nutritional value of milk over time. Any point on this curve can be compared to another point to measure and/or describe the change in nutritional value, or the ΔN of nutritional substance A. The plot of the degradation in the same nutritional value of nutritional substance B, also milk, describes the change in nutritional value, or the ΔN of nutritional substance B, a nutritional substance which starts out with a higher nutritional value than nutritional substance A, but degrades over time more quickly than nutritional substance A.

In one example, where nutritional substance A and nutritional substance B are steaks, this ΔN information regarding the nutritional substance degradation profile of each steak could be used by the consumer in the selection and/or consumption of the steak. If the consumer has this information at time zero when selecting a steak product for purchase, the consumer could consider when the consumer plans to consume the steak, whether that is on one occasion or multiple occasions. For example, if the consumer planned to consume the steak prior to the point when the curve represented by nutritional substance B crosses the curve represented by nutritional substance A, then the consumer should choose the steak represented by nutritional substance B because it has a higher nutritional value until it crosses the curve represented by nutritional substance A. However, if the consumer expects to consume at least some of the steak at a point in time after the time when the curve represented by nutritional substance B crosses the curve represented by nutritional substance A, then the consumer might choose to select the steak represented by the nutritional substance A, even though steak represented by nutritional substance A has a lower nutritional value than the steak represented by nutritional substance B at an earlier time. This change to a desired nutritional value in a nutritional substance over a change in a condition of the nutritional substance described in FIG. 2 can be measured and/or controlled throughout nutritional substance supply system 10 in FIG. 1. This example demonstrates how dynamically generated information regarding a ΔN of a nutritional substance, in this case a change in nutritional value of steak, can be used to understand a rate at which that nutritional value changes or degrades; when that nutritional value expires; and a residual nutritional value of the nutritional substance over a change in a condition of the nutritional substance, in this example a change in time. This ΔN information could further be used to determine a best consumption date for nutritional substance A and B, which could be different from each other depending upon the dynamically generated information generated for each.

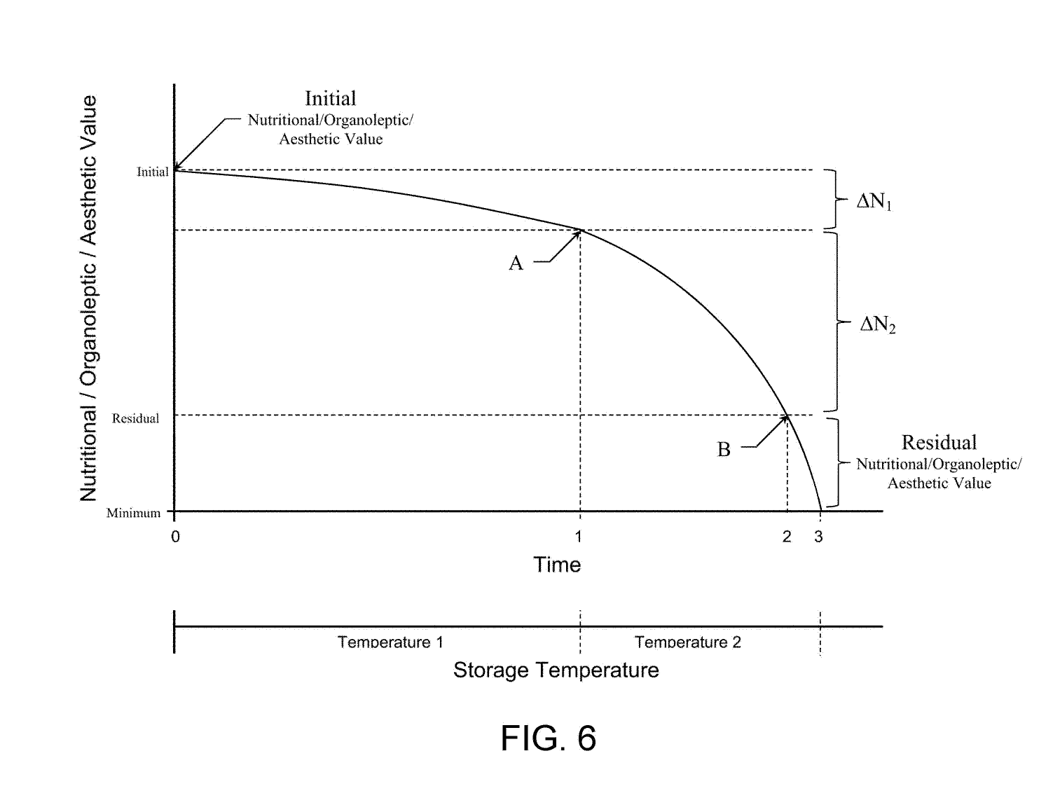

FIG. 6 is a graph showing the function of how a nutritional, organoleptic, or aesthetic value of a nutritional substance varies over a change in time and a change in a second condition, the storage temperature of the nutritional substance. It is understood that change in time and change in storage temperature are offered by way of example, and are in no way limiting to the types on condition changes to which the present inventions may be applied. As an example, the change in a nutritional property of steak is shown over a period of time including its preservation at the supermarket and a subsequent period of time including its local storage in a consumer's refrigerator, which is a local storage environment according to the present invention. The graph shows that the steak is preserved at a first temperature, Temperature 1, for a first period of time indicated as 0 to 1, while at the supermarket. The steak is purchased by a consumer at time 1, and subsequently stored at a second temperature, Temperature 2, for a second period of time indicated as 1 to 3, during local storage in the refrigerator, which is a local storage environment according to the present invention. It is noted that Temperature 2 is greater than Temperature 1, and accordingly the shape of the graph changes at point A when the steak is taken from Temperature 1 and stored at Temperature 2. As in the preservation module, the local storage environment can identify the steak stored within it by reading or scanning its dynamic information identifier (or by the consumer entering it), can communicate with the nutritional substance information module, and accordingly can determine the steak's ΔN prior to placement within the refrigerator, and continue to track the steak's ΔN while in the refrigerator. The refrigerator is provided with a consumer interface, such as a screen, keyboard, sound system, or any known consumer interface. The consumer interface enables the refrigerator to communicate to the consumer that it contains the particular carton of steak, information related to ΔN, including current nutritional, organoleptic, and aesthetic values of the steak, and when the steak will reach a minimum acceptable nutritional, organoleptic, or aesthetic value, indicated by “Minimum” on the vertical axis of the graph. The minimum acceptable values may be automatically provided by the information module, may be provided by the consumer through the consumer interface, or may be the higher of the two values. In this case the consumer can see how the nutritional value of the steak has degraded prior to purchasing it, and can continue to see how the nutritional value degrades during local storage after its purchase, and when it will reach its minimum acceptable nutritional value. For example, at the time indicated as 2, the consumer can determine the residual nutritional value of the steak, corresponding to point B and “Residual” on the vertical axis of the graph. Further, the consumer can determine the steak's nutritional value will reach a minimum acceptable level at time 3, as indicated by “Minimum” on the vertical axis of the graph, thus knowing the window of time in which the steak will maintain an acceptable nutritional level, as indicated by time 1 to 3. Further, the refrigerator can notify the consumer through its consumer interface when the steak's nutritional value has reached or fallen below the minimum acceptable value.

In fact, if the consumer knows the internal temperature of his own refrigerator prior to purchasing the steak, he can predict the degradation of nutritional value of the steak that will occur after he purchases it and locally stores it in his refrigerator, thus knowing the window of time in which it will maintain an acceptable nutritional level, as indicated by time 1 to 3. For example, the consumer may utilize an application on his smartphone to store, or even monitor, the internal temperature of his refrigerator. When he goes to the supermarket, he could scan the steak's dynamic information identifier with his smartphone, and the application can communicate with the nutritional substance information module to determine a current ΔN, and predict the ΔN of the steak when stored in his refrigerator. Further, the consumer may utilize such an application on his smartphone to store, or even monitor, the internal conditions of various local storage environments, local storage containers, and local storage coupons. In this way, when he goes to the supermarket, he can scan the dynamic information identifier of a wide variety of nutritional substances with his smartphone, and the application can communicate with the nutritional substance information module to determine a current ΔN, and predict the ΔN of the nutritional substance when stored in the corresponding local storage environment or local storage container.

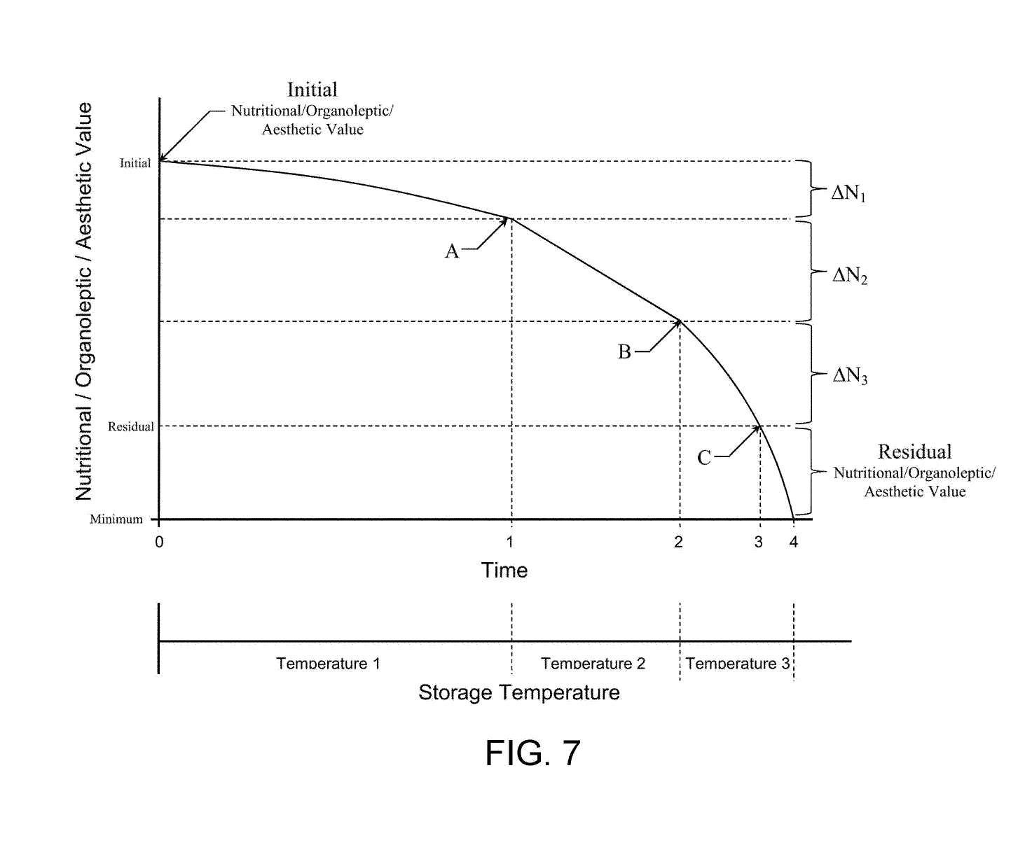

FIG. 7 is a graph showing the function of how a nutritional, organoleptic, or aesthetic value of a nutritional substance varies over a change in time and multiple changes in a second condition, the storage temperature of the nutritional substance. It is understood that change in time and change in storage temperature are offered by way of example, and are in no way limiting to the types on condition changes to which the present inventions may be applied. In this example, the change in a nutritional property of potato salad is shown over a period of time including its preservation at the supermarket and a subsequent period of time including its local storage in a consumer's refrigerator, which is a local storage environment according to the present invention, and subsequent storage in the consumer's picnic cooler, which contains a local storage coupon according to the present invention. The graph shows that the potato salad is preserved at a first temperature, Temperature 1, for a first period of time indicated as 0 to 1, while at the supermarket. The potato salad is purchased by a consumer at time 1, and subsequently stored at a second temperature, Temperature 2, for a second period of time indicated as 1 to 2, during local storage in the consumer's refrigerator, which is a local storage environment according to the present invention. It is noted that Temperature 2 is greater than Temperature 1, and accordingly the shape of the graph changes at point A when the potato salad is taken from Temperature 1 and stored at Temperature 2. As in the preservation module, the local storage environment can identify the potato salad stored within it by reading or scanning its dynamic information identifier (or by the consumer entering it), can communicate with the nutritional substance information module, and accordingly can determine the potato salad's ΔN prior to placement within the refrigerator, and continue to track the potato salad's ΔN while in the refrigerator. The refrigerator is provided with a consumer interface, such as a screen, keyboard, sound system, or any known consumer interface. The consumer interface enables the refrigerator to communicate to the consumer that it contains the particular container of potato salad, information related to ΔN, including current nutritional, organoleptic, and aesthetic values of the potato salad while stored in the refrigerator. At time 2, the potato salad is taken from the refrigerator and placed inside the consumer's traditional picnic cooler, along with a coupon according to the present invention, where it is stored at Temperature 3, for a period of time indicated as 2 to 4. It is noted that Temperature 3 is greater than Temperature 2, and accordingly the shape of the graph changes at point B when the potato salad is taken from Temperature 2 and stored at Temperature 3. The local storage coupon can identify the potato salad stored within it by reading or scanning its dynamic information identifier (or by the consumer entering it), can communicate with the nutritional substance information module, and accordingly can determine the potato salad's ΔN prior to placement within the cooler, and continue to track the potato salad's ΔN while in the cooler. The coupon is provided with a consumer interface, such as a screen, keyboard, sound system, or any known consumer interface, or alternatively, an application on the consumer's smartphone can enable the coupon to communicate with the smartphone such that the smartphone acts as the consumer interface. The consumer interface enables the coupon to communicate to the consumer that the cooler contains the particular container of potato salad, information related to ΔN, including current nutritional, organoleptic, and aesthetic values of the potato salad while stored in the cooler, and when the potato salad will reach a minimum acceptable nutritional, organoleptic, or aesthetic value, indicated by “Minimum” on the vertical axis of the graph. The minimum acceptable values may be automatically provided by the information module, may be provided by the consumer through the consumer interface, or may be the higher of the two values. In this case the consumer can see how the nutritional value of the potato salad has degraded prior to placing it in the cooler with the coupon, and can continue to see how the nutritional value degrades during local storage in the cooler, and when it will reach its minimum acceptable nutritional value. For example, at the time indicated as 3, the consumer can determine the residual nutritional value of the potato salad, corresponding to point C and “Residual” on the vertical axis of the graph. Further, the consumer can determine the potato salad's nutritional value will reach a minimum acceptable level at time 4, as indicated by “Minimum” on the vertical axis of the graph, thus knowing the window of time in which the potato salad in the cooler will maintain an acceptable nutritional level, as indicated by time 2 to 4. Further, the coupon can notify the consumer through the consumer interface when the potato salad's nutritional value has reached or fallen below the minimum acceptable value.

It is understood that local storage environments according to the present invention can comprise any local storage environment for a nutritional substance provided with the features enabling it to identify a dynamic information identifier on the nutritional substance, track one or more conditions related to a ΔN of the nutritional substance, communicate with the nutritional substance information module, determine a current ΔN, track and predict the ΔN of the nutritional substance while stored therein, and communicate information related to the ΔN to a consumer. Examples of such local storage environments include, but are not limited to: a pantry capable of identifying a dynamic information identifier on canned or bottled goods and tracking one or more conditions related to a ΔN of the canned or bottled goods, such as time and storage temperature; a shelf capable of identifying a dynamic information identifier on dry goods and tracking one or more conditions related to a ΔN of the dry goods, such as time and storage humidity; a vegetable bin capable of identifying a dynamic information identifier on vegetables and tracking one or more conditions related to a ΔN of the vegetables, such as time, storage temperature, and storage humidity; a drawer capable of identifying a dynamic information identifier on fruit and tracking one or more conditions related to a ΔN of the fruit, such as time, storage temperature, and exposure to light; a medicine cabinet capable of identifying a dynamic information identifier on medicaments and tracking one or more conditions related to a ΔN of the medicaments, such as time, storage temperature, storage humidity, and exposure to light. These local storage environments may be provided with a consumer interface, such as a screen, keyboard, sound system, or any known consumer interface. The consumer interface enables the local storage environment to communicate to the consumer that it contains a particular nutritional substance, information related to its ΔN, including current nutritional, organoleptic, and aesthetic values of the nutritional substance while stored in the local storage environment.

In FIG. 1, Creation module 200 can dynamically encode nutritional substances to enable the tracking of changes in nutritional, organoleptic, and/or aesthetic value of the nutritional substance, or ΔN. This dynamic encoding, also referred to herein as a dynamic information identifier, can replace and/or complement existing nutritional substance marking systems such as barcodes, labels, and/or ink markings. This dynamic encoding, or dynamic information identifier, can be used to make nutritional substance information from creation module 200 available to information module 100 for use by preservation module 300, transformation module 400, conditioning module 500, and/or consumption module 600, which includes the ultimate consumer of the nutritional substance. One method of marking the nutritional substance with a dynamic information identifier by creation module 200, or any other module in nutritional supply system 10, could include an electronic tagging system, such as the tagging system manufactured by Kovio of San Jose, Calif., USA. Such thin film chips can be used not only for tracking nutritional substances, but can include components to measure attributes of nutritional substances, and record and transmit such information. Such information may be readable by a reader including a satellite-based system. Such a satellite-based nutritional substance information tracking system could comprise a network of satellites with coverage of some or all the surface of the earth, so as to allow the dynamic nutritional value database of information module 100 real time, or near real time updates about a ΔN of a particular nutritional sub stance.

Preservation module 300 includes packers and shippers of nutritional substances. The tracking of changes in nutritional, organoleptic, and/or aesthetic values, or a ΔN, during the preservation period within preservation module 300 allows for dynamic expiration dates for nutritional substances. For example, expiration dates for dairy products are currently based generally only on time using assumptions regarding minimal conditions at which dairy products are maintained. This extrapolated expiration date is based on a worst-case scenario for when the product becomes unsafe to consume during the preservation period. In reality, the degradation of dairy products may be significantly less than this worst-case. If preservation module 300 could measure or derive the actual degradation information such as ΔN, an actual expiration date, referred to herein as a dynamic expiration date, can be determined dynamically, and could be significantly later in time than an extrapolated expiration date. This would allow the nutritional substance supply system to dispose of fewer products due to expiration dates. This ability to dynamically generate expiration dates for nutritional substances is of particular significance when nutritional substances contain few or no preservatives. Such products are highly valued throughout nutritional substance supply system 10, including consumers who are willing to pay a premium for nutritional substances with few or no preservatives.

It should be noted that a dynamic expiration date need not be indicated numerically (i.e., as a numerical date) but could be indicated symbolically as by the use of colors—such as green, yellow and red employed on semaphores—or other designations. In those instances, the dynamic expiration date would not be interpreted literally but, rather, as a dynamically-determined advisory date. In practice a dynamic expiration date will be provided for at least one component of a single or multi-component nutritional substance. For multi-component nutritional substances, the dynamic expiration date could be interpreted as a “best’ date for consumption for particular components.

Information about changes in nutritional, organoleptic, and/or aesthetic values of nutritional substances, or ΔN, is particularly useful in the conditioning module 500 of the present invention, as it allows knowing, or estimating, the pre-conditioning state of the nutritional, organoleptic, and/or aesthetic values of the nutritional substance, including the changes in nutritional, organoleptic, and/or aesthetic values occurring during local storage of the nutritional substance, and further allows for estimation of a ΔN associated with proposed conditioning parameters. The conditioning module 500 can therefore create conditioning parameters, such as by modifying existing or baseline conditioning parameters, to deliver desired nutritional, organoleptic, and/or aesthetic values after conditioning. The pre-conditioning state of the nutritional, organoleptic, and/or aesthetic value of a nutritional substance is not tracked or provided to the consumer by existing conditioners, nor is the ΔN expected from a proposed conditioning tracked or provided to the consumer either before or after conditioning. However, using information provided by information module 100 from creation module 200, preservation module 300, transformation module 400, and consumer feedback and updates related to ΔN, preferably obtained through or provided by local storage environments, local storage containers, and local storage coupons according to the present invention, and/or information measured or generated by conditioning module 500, and/or consumer input provided through the conditioning module 500, conditioning module 500 could provide the consumer with the actual, and/or estimated change in nutritional, organoleptic, and/or aesthetic values of the nutritional substance, or ΔN.

The information regarding nutritional substances provided by information module 100 to consumption module 600 can replace or complement existing information sources such as recipe books, food databases like www.epicurious.com, and Epicurious apps. Through the use of specific information regarding a nutritional substance from information module 100, consumers can use consumption module 600 to select nutritional substances according to nutritional, organoleptic, and/or aesthetic values. This will further allow consumers to make informed decisions regarding nutritional substance additives, preservatives, genetic modifications, origins, traceability, and other nutritional substance attributes that may also be tracked through the information module 100. This information can be provided by consumption module 600 through personal computers, laptop computers, tablet computers, and/or smartphones. Software running on these devices can include dedicated computer programs, modules within general programs, and/or smartphone apps. An example of such a smartphone app regarding nutritional substances is the iOS ShopNoGMO from the Institute for Responsible Technology. This iPhone app allows consumers access to information regarding non-genetically modified organisms they may select. Additionally, consumption module 600 may provide information for the consumer to operate conditioning module 500 in such a manner as to optimize nutritional, organoleptic, and/or aesthetic values of a nutritional substance and/or component nutritional substances thereof, according to the consumer's needs or preference or according to target values established by the provider of the nutritional substance, such as the transformer, and/or minimize degradation of, preserve, or improve nutritional, organoleptic, and/or aesthetic value of a nutritional substance and/or component nutritional substances thereof.

Through the use of nutritional substance information available from information module 100 nutritional substance supply system 10 can track nutritional, organoleptic, and/or aesthetic value. Using this information, nutritional substances travelling through nutritional substance supply system 10 can be dynamically valued and priced according to nutritional, organoleptic, and/or aesthetic values. For example, nutritional substances with longer dynamic expiration dates (longer shelf life) may be more highly valued than nutritional substances with shorter expiration dates. Additionally, nutritional substances with higher nutritional, organoleptic, and/or aesthetic values may be more highly valued, not just by the consumer, but also by each entity within nutritional substance supply system 10. This is because each entity will want to start with a nutritional substance with higher nutritional, organoleptic, and/or aesthetic value before it performs its function and passes the nutritional substance along to the next entity. Therefore, both the starting nutritional, organoleptic, and/or aesthetic value and the ΔN associated with those values are important factors in determining or estimating an actual, or residual, nutritional, organoleptic, and/or aesthetic value of a nutritional substance, and accordingly are important factors in establishing dynamically valued and priced nutritional substances.

For example, the producer of a ready-to-eat dinner would prefer to use corn of a high nutritional, organoleptic, and/or aesthetic value in the production of its product, the ready-to-eat dinner, so as to produce a premium product of high nutritional, organoleptic, and/or aesthetic value. Depending upon the levels of the nutritional, organoleptic, and/or aesthetic values, the ready-to-eat dinner producer may be able to charge a premium price and/or differentiate its product from that of other producers. When selecting the corn to be used in the ready-to-eat dinner, the producer will seek corn of high nutritional, organoleptic, and/or aesthetic value from preservation module 300 that meets its requirements for nutritional, organoleptic, and/or aesthetic value. The packager/shipper of preservation module 300 would also be able to charge a premium for corn which has high nutritional, organoleptic, and/or aesthetic values. And finally, the packager/shipper of preservation module 300 will select corn of high nutritional, organoleptic, and/or aesthetic value from the grower of creation module 200, who will also be able to charge a premium for corn of high nutritional, organoleptic, and/or aesthetic values.

Further, the consumer of the ready-to-eat dinner may want to, or in the case of a restaurant, cafeteria, or other regulated eating establishment, may be required to, track the nutritional, organoleptic, and/or aesthetic value of the corn during the local storage of the ready-to-eat dinner. The local storage environments, local storage containers, and local storage coupons of the present invention enable such tracking by making information related to ΔN during local storage available to information module 100 for updating the dynamic nutritional, organoleptic, and aesthetic values of a nutritional substance.

The change to nutritional, organoleptic, and/or aesthetic value for a nutritional substance, or ΔN, tracked through nutritional substance supply system 10 through nutritional substance information from information module 100 can be preferably determined from measured information. However, some or all such nutritional substance ΔN information may be derived through measurements of environmental conditions of the nutritional substance as it travelled through nutritional substance supply system 10. Additionally, some or all of the nutritional substance ΔN information can be derived from ΔN data of other nutritional substances which have travelled through nutritional substance supply system 10. Nutritional substance ΔN information can also be derived from laboratory experiments performed on other nutritional substances, which may approximate conditions and/or processes to which the actual nutritional substance has been exposed.

For example, laboratory experiments can be performed on bananas to determine effect on or change in nutritional, organoleptic, and/or aesthetic value, or ΔN, for a variety of environmental conditions bananas may be exposed to during packaging and shipment in preservation module 300. Using this experimental data, tables and/or algorithms could be developed which would predict the level of change of nutritional, organoleptic, and/or aesthetic values, or ΔN, for a particular banana based upon information collected regarding the environmental conditions to which the banana was exposed during its time in preservation module 300. While the ultimate goal for nutritional substance supply system 10 would be the actual measurement of nutritional, organoleptic, and/or aesthetic values to determine ΔN, use of derived nutritional, organoleptic, and/or aesthetic values from experimental data to determine ΔN would allow improved logistics planning because it provides the ability to prospectively estimate changes to nutritional, organoleptic, and/or aesthetic values, or ΔN, and because it allows more accurate tracking of changes to nutritional, organoleptic, and/or aesthetic values, or ΔN, while technology and systems are put in place to allow actual measurement.

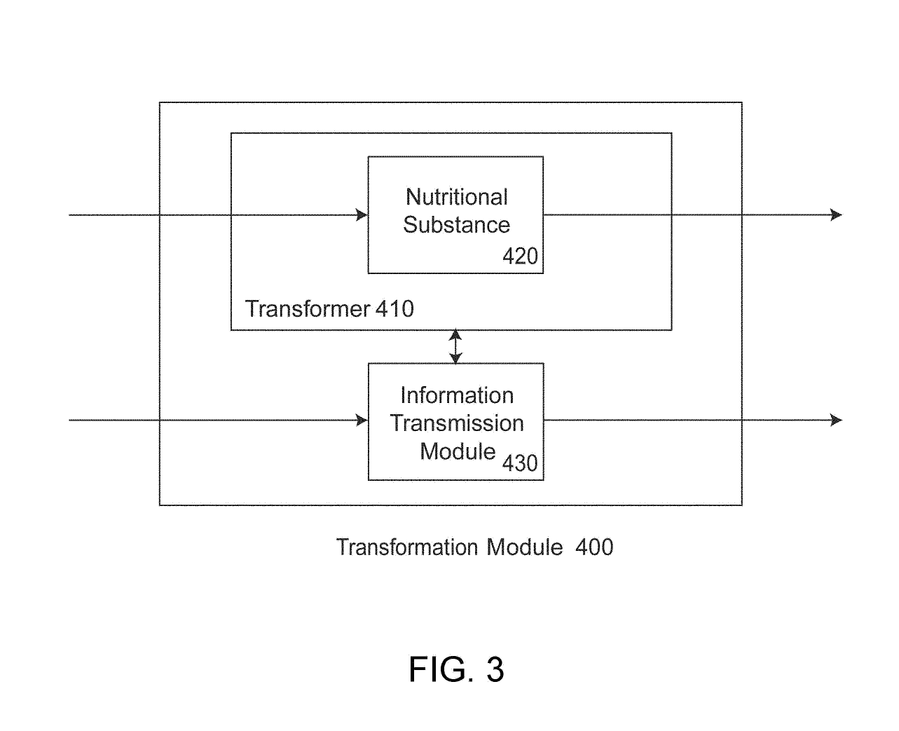

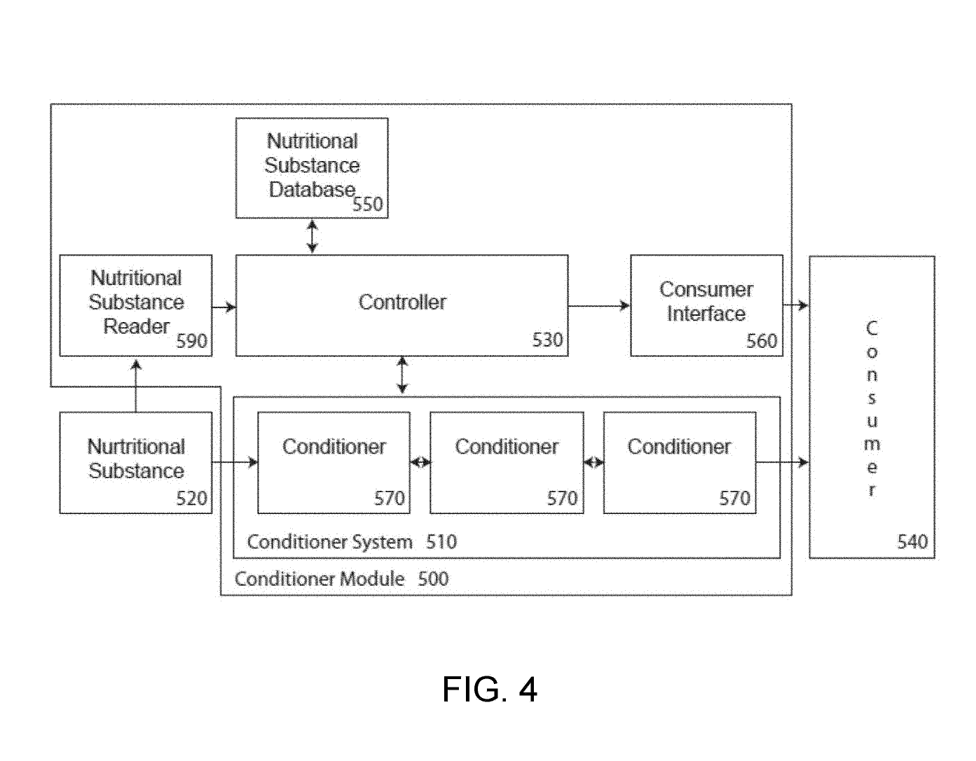

FIG. 4 shows an embodiment of conditioner module 500 of the present invention. Conditioner system 510 receives nutritional substance 520 for conditioning before it is delivered to consumer 540. Controller 530 is operably connected to conditioner system 510. In fact, controller 530 may be integrated within conditioner system 510, or provided as a separate device, shown in FIG. 3.

In an embodiment of the present invention, conditioner 570 is provided without controller 530, however it is provided in a format to be compatible with controller 530. Such a conditioner is also referred to herein as an information capable conditioner. In contrast, traditional conditioners, also referred to herein as dumb conditioners, are not information capable, are not compatible with controller 530, and accordingly will always be dumb conditioners. As information enabled nutritional substances and conditioning systems according to the present invention are increasingly available, dumb conditioners will become increasingly obsolete.

Information capable conditioners may be provided in a variety of configurations known to those skilled in the art, and the examples offered herein are for purposed of illustration and not intended to be limiting in any way. In one example of an information capable conditioner, it is provided with traditional functionality, that is, it will interact with nutritional substances in a traditional fashion, whether the nutritional substance is information enabled or not. However, the information capable conditioner is compatible with separately available controller 530, such that at any time during or after the manufacture and sale of the information capable conditioner, controller 530 may be coupled with the information capable conditioner to enable the full functionality and benefit of conditioner module 500. Information capable conditioners provide appliance manufacturers and consumers great flexibility, and will not become obsolete like dumb conditioners.

The coupling of controller 530 to the information capable conditioner may take any physical and/or communication format known to those skilled in the art. These may include, but are not limited to: an information capable conditioner provided with Bluetooth, or other wireless near-field communication capability, to communicate with a communication-compatible controller 530 which may be any of a completely separate unit, an externally attachable unit, and an internally placed unit; an information capable conditioner provided with a USB port, or other electronic communication capability, to communicate with a communication-compatible controller 530 which may be any of a completely separate unit, an externally attachable unit, and an internally placed unit; an information capable conditioner provided with a fiber optic port, or other optical communication capability, to communicate with a communication-compatible controller 530 which may be any of a completely separate unit, an externally attachable unit, and an internally placed unit; or an information capable conditioner provided with WiFi, or other wireless communication capability, to communicate with a WiFi compatible controller 530 which may be any of a completely separate unit, an externally attachable unit, and an internally placed unit. It is understood that the controller 530 may be provided with its own consumer interface, may communicate and be operated through the consumer interface provided with the information capable conditioner, or a combination of both.

When conditioner system 510 receives nutritional substance 520 for conditioning, nutritional substance reader 590 either receives information regarding nutritional substance 520 and provides it to controller 530, which is the case if the nutritional substance 520 contains a label which includes the information about nutritional substance 520, and/or the nutritional substance reader 590 receives reference information allowing retrieval of the information and provides it to controller 530, which is the case if the nutritional substance 520 is associated with, or provided with a dynamic information identifier. In the case where nutritional substance 520 contains a label which includes the desired information about nutritional substance 520, nutritional substance reader 590 reads this information, provides it to controller 530, which makes it available to consumer 540 by means of consumer interface 560.

For example, if nutritional substance 520 is a ready-to-eat frozen dinner which needs to be heated by conditioner system 510, nutritional substance reader 590 would read a label on nutritional substance 520, thereby receiving the information regarding nutritional substance 520, and then provide the information to controller 530. This information could include creation information as to the creation of the various components which constitute the ready-to-eat dinner. This information could include information about where and how the corn in the ready-to-eat dinner was grown, including the corn seed used, where it was planted, how it was planted, how it was irrigated, when it was picked, and information on fertilizers and pesticides used during its growth. Additionally, this information could include the cattle lineage, health, immunization, dietary supplements that were fed to the cattle that was slaughtered to obtain the beef in the ready-to-eat dinner.

The information from a label on nutritional substance 520 could also include information on how the components were preserved for shipment from the farm or slaughterhouse on their path to the nutritional substance transformer who prepared the ready-to-eat dinner. Additional information could include how the nutritional substance transformer transformed the components into the ready-to-eat dinner, such as recipe used, additives to the dinner, and actual measured conditions during the transformation into the ready-to-eat dinner.

While such information could be stored on a label located on the packaging for nutritional substance 520 so as to be read by nutritional substance reader 590, provided to controller 530, and provided to consumer interface 560 for display to consumer 540, preferably, the label on the nutritional substance package includes reference information, such as a dynamic information identifier, which is read by nutritional substance reader 590 and provided to controller 530 that allows controller 530 to retrieve the information about nutritional substance 520 from nutritional substance database 550. Further, linking consumer feedback and updates regarding observed or measured changes in the nutritional, organoleptic, and/or aesthetic values of nutritional substances would provide for virtually real time updates of ΔN information from the actual consumer.

Nutritional substance database 550 could be a database maintained by the transformer of nutritional substance 520 for access by consumers of such nutritional substance 520 to track or estimate changes in the nutritional, organoleptic, and/or aesthetic values of those nutritional substances, as well as any other information about the nutritional substance that can be tracked, including but not limited to the examples previously described. However, preferably, nutritional substance database 550 is a database maintained by the nutritional substance industry for all such information regarding nutritional substances grown, raised, preserved, transformed, conditioned and consumed by consumer 540, in which case it is the database contained within information module 100 and also referred to herein as a dynamic nutritional value database.

It is important to note that while the Figures illustrate various embodiments of the present invention show nutritional substance database 550 as part of the conditioner module 500, they are in no way limited to this interpretation. It is understood that this convention is only one way of illustrating the inventions described herein, and it is further understood that this is in no way limiting to the scope of the present invention. The same is understood for recipe database 555, consumer database 580, and nutritional substance industry database 558.

In an alternate embodiment of the present invention, controller 530, in addition to providing information regarding nutritional substance 520 to consumer 540, also receives information from conditioner system 510 on how nutritional substance 520 was conditioned. Additionally, conditioner system 510 may also measure or sense information about nutritional substance 520 during its conditioning by conditioner system 510, and provide such information to controller 530, so that such information could also be provided to consumer 540, via consumer interface 560. Further, the controller 530 can receive information from the consumer via consumer interface 560 regarding observed or measured changes in the nutritional, organoleptic, and/or aesthetic values of nutritional substances before or after conditioning, to provide virtually real time updates of ΔN information from the actual consumer, for use by the controller and/or transmission to the nutritional substance database 550.

In a preferred embodiment of the present invention, controller 530 organizes and correlates the information it receives regarding nutritional substance 520 from the various sources of such information, including nutritional substance database 550 and conditioner system 510, and presents such information through consumer interface 560 to consumer 540 in a manner useful to consumer 540. For example, such information may be provided in a manner that assists consumer 540 in understanding how nutritional substance 520 meets consumer's 540 nutritional needs. It could organize information regarding nutritional substance 520 to track consumer's 540 weight loss program. Controller 530 could have access to, or maintain, information regarding consumer 540, so as to track and assist consumer 540 in meeting their specific nutritional needs.

In another embodiment of the present invention conditioner system 510 could be a plurality of conditioner devices which can be selectively operated by controller 530 to prepare nutritional substance 520. Conditioner system 510 can be either a single conditioning device, such as a microwave oven, conventional oven, toaster, blender, steamer, stovetop, or human cook. Conditioner system 510 may be a plurality of conditioners 570. In the case where a plurality of conditioners 570 comprise conditioner system 510, nutritional substance 520 may be manually or automatically transferred between conditioners 570 for eventual transfer to consumer 540.

Nutritional substance reader 590 may be an automatic reader such as a barcode reader or RFID sensor which receives information from nutritional substance 520 or a reference code from nutritional substance 520, such as a dynamic information identifier associated with, or provided with the nutritional substance 520, and provides this information to controller 530. Nutritional substance reader 590 might also be a manual entry system where the reference code, such as a dynamic information identifier associated with, or provided with the nutritional substance 520, is manually entered into nutritional substance reader 590 for use by controller 530, or may alternatively be manually entered into consumer interface 560 for use by controller 530. Alternatively, nutritional substance reader 590 may be a voice system, where the relevant information is transmitted by voice.

Nutritional substance database 550 could be a flat database, relational database or, preferably, a multi-dimensional database. Nutritional substance database 550 could be local but, preferably, it would be located remotely, such as on the internet, and accessed via a telecommunication system, such as a wireless telecommunication system. Controller 530 can be implemented using a computing device, such as a micro-controller, micro-processor, personal computer, or tablet computer. Controller 530 could be integrated to include nutritional substance reader 590, consumer interface 560, and/or nutritional substance database 550. Additionally, controller 530 may be integrated in conditioner system 510, including integration into conditioner 570.

Nutritional substance database 550 could be a database maintained by the transformer of nutritional substance 520 for access by consumers of such nutritional substance 520 to track or estimate changes in the nutritional, organoleptic, and/or aesthetic values of those nutritional substances, as well as any other information about the nutritional substance that can be tracked, including but not limited to the examples previously described. However, preferably, nutritional substance database 550 is a database within information module 100 that is maintained by the nutritional substance industry for all such information regarding nutritional substances grown, raised, preserved, transformed, conditioned and consumed by consumer 540, in which case it is the database contained within information module 100 and also referred to herein as a dynamic nutritional value database.

In an alternate embodiment of the present invention, controller 530, in addition to providing information regarding nutritional substance 520 to consumer 540, also receives information from conditioner system 510 on how nutritional substance 520 was conditioned. Additionally, conditioner system 510 may also measure or sense information about nutritional substance 520 during its conditioning by conditioner system 510, and provide such information to controller 530, so that such information could also be provided to consumer 540, via consumer interface 560.

In a preferred embodiment of the present invention, controller 530 organizes and correlates the information it receives regarding nutritional substance 520 from the various sources of such information, including nutritional substance database 550 and conditioner system 510, and presents such information through consumer interface 560 to consumer 540 in a manner useful to consumer 540. For example, such information may be provided in a manner that assists consumer 540 in understanding how nutritional substance 520 meets consumer's 540 nutritional needs before or after conditioning, or how it meets the consumer's needs based on various proposed conditioning parameters. It could organize information regarding nutritional substance 520 to track consumer's 540 weight loss program. Controller 530 could have access to, or maintain, information regarding consumer 540, so as to track and assist consumer 540 in meeting their specific nutritional needs.

In another embodiment of the present invention conditioner system 510 could be a plurality of conditioner devices which can be selectively operated by controller 530 to prepare nutritional substance 520. Conditioner system 510 can be either a single conditioning device, such as a microwave oven, conventional oven, toaster, blender, steamer, stovetop, or human cook. Conditioner system 510 may be a plurality of conditioners 570. In the case where a plurality of conditioners 570 comprise conditioner system 510, nutritional substance 520 may be manually or automatically transferred between conditioners 570 for eventual transfer to consumer 540.

Consumer interface 560 can be implemented as a display device mounted on controller 530, conditioner system 510, or conditioner 570. However, consumer interface 560 is preferably a tablet computer, personal computer, personal assistant, or smart phone, running appropriate software, such as an app.

While conditioner module 500 can be located in the consumer's home, conditioner module 500 may be located at a restaurant or other food service establishment for use in preparing nutritional substances 520 for consumers who patronize such an establishment. Additionally, conditioner module 500 could be located at a nutritional substance seller such as a grocery store or health food store for preparation of nutritional substances 520 purchased by consumers at such an establishment. It could be foreseen that conditioner modules 500 could become standalone businesses where consumers select nutritional substances for preparation at the establishment or removal from the establishment for consumption elsewhere.

Additionally, controller 530 uses nutritional substance information retrieved by nutritional substance reader 590 from nutritional substance 520, or retrieved from nutritional substance database 550 using reference information obtained by nutritional substance reader 590 from nutritional substance 520, to dynamically modify the operation of conditioner system 510 to maintain organoleptic and nutritional properties of nutritional substance 520. For example, if the nutritional substance 520 is a ready-to-eat dinner, controller 530 could modify the instructions to conditioner system 530 in response to information regarding the corn used in the ready-to-eat dinner such that a temperature and cooking duration can be modified to affect the organoleptic, nutritional, taste, and/or appearance of the corn.

In an additional embodiment of the present invention, consumer 540 provides information regarding their needs and/or desires with regard to the nutritional substance 520 to consumer interface 560. Consumer interface 560 provides this information to controller 530 so as to allow controller 530 to dynamically modify conditioning parameters used by conditioner system 510 in the conditioning of nutritional substance 520, or to request from nutritional substance database 550 dynamically modified conditioning parameters to be used by conditioner system 510 in the conditioning of nutritional substance 520. Consumer's 540 needs and/or desires could include nutritional parameters, taste parameters, aesthetic parameters. For example, consumer 540 may have needs for certain nutrients which are present in nutritional substance 520 prior to conditioning. Controller 530 could modify operation of conditioner system 510 so as to preserve such nutrients. For example, conditioner system 500 can cook the nutritional substance at a lower temperature and/or for a shorter duration so as to minimize nutrient loss. The consumer's 540 needs and/or desires may be related to particular nutritional, organoleptic, an/or aesthetic values, and may additionally be related to other nutritional substance attributes that are retrievable through the nutritional substance database 550 using a dynamic information identifier, such as nutritional substance additives, preservatives, genetic modifications, origins, and traceability. Further, the consumer's needs and/or desires could be part of a consumer profile provided to the controller 530 through the consumer interface 560 or otherwise available to controller 530. The consumer's needs and/or desires could be exclusionary in nature, for example no products of animal origin, no peanuts or peanut-derived products, no farm raised products, no pork products, or no imported products. In these cases, the nutritional substance database 550 could provide information that would prevent the consumer from preparing and/or consuming products that the consumer cannot, should not, or prefers not to consume.

The consumer's 540 organoleptic and/or aesthetic desires could include how rare or well done they prefer a particular nutritional substance to be prepared. For example, consumer 540 may prefer his vegetables to be crisp or pasta to be prepared al dente. With such information provided by consumer 540 to controller 530 through consumer interface 560, controller 530 can dynamically modify operation of conditioner system 510 responsive to the consumer information and provide a nutritional substance according to the consumer's desires.

In the preferred embodiment of the present invention, controller 530 receives information regarding the history of nutritional substance 520, current information on nutritional substance 520, and consumer 540 needs and/or desires, and dynamically modifies operation of conditioner system 510 responsive to the information so as to provide a nutritional substance according to the consumer's needs and/or desires. For example, if nutritional substance 520 is a steak, controller 530 would receive reference information regarding the steak, nutritional substance 520, from nutritional substance reader 590. Controller 530 would use this reference information to obtain information about the steak from nutritional substance database 550. Controller 530 could also receive current information about the steak from nutritional substance reader 590 and/or conditioner 510. Additionally, controller 530 could receive consumer 540 preferences from consumer interface 560. Finally, controller 530 could receive information from conditioner system 510 during the conditioning of the steak, nutritional substance 520. Using some or all of such information, controller 530 would dynamically modify the cooking of the steak to preserve, optimize, or enhance organoleptic, nutritional, and aesthetic properties to meet consumer 540 needs. For example, the steak could be cooked slowly to preserve iron levels within the meat, and also cooked to well-done to meet consumer's 540 taste.

In a preferred embodiment of the present invention, controller 530 organizes and correlates the information it receives regarding nutritional substance 520 from the various sources of such information, including nutritional substance database 550 and conditioner system 510, and presents such information through consumer interface 560 to consumer 540 in a manner useful to consumer 540. For example, such information may be provided in a manner that assists consumer 540 in understanding how nutritional substance 520 meets consumer's 540 nutritional needs before or after conditioning, or how it meets the consumer's needs based on various proposed conditioning parameters. It could organize information regarding nutritional substance 520 to track consumer's 540 weight loss program. Controller 530 could have access to, or maintain, information regarding consumer 540, so as to track and assist consumer 540 in meeting their specific nutritional needs.

Consumer interface 560 can be implemented as a display device mounted on controller 530, conditioner system 510, or conditioner 570. However, consumer interface 560 is preferably a tablet computer, personal computer, personal assistant, microphone, voice activated device, gesture activated device, smart phone and the like, running appropriate software, such as an app.

The consumer's 540 nutritional, organoleptic or aesthetic desires could include how rare or well done they prefer a particular nutritional substance to be prepared. For example, consumer 540 may prefer his vegetables to be crisp or pasta to be prepared al dente. With such information provided by consumer 540 to controller 530 through consumer interface 560, controller 530 can dynamically modify operation of conditioner system 510 responsive to the consumer information and provide a nutritional substance according to the consumer's desires.

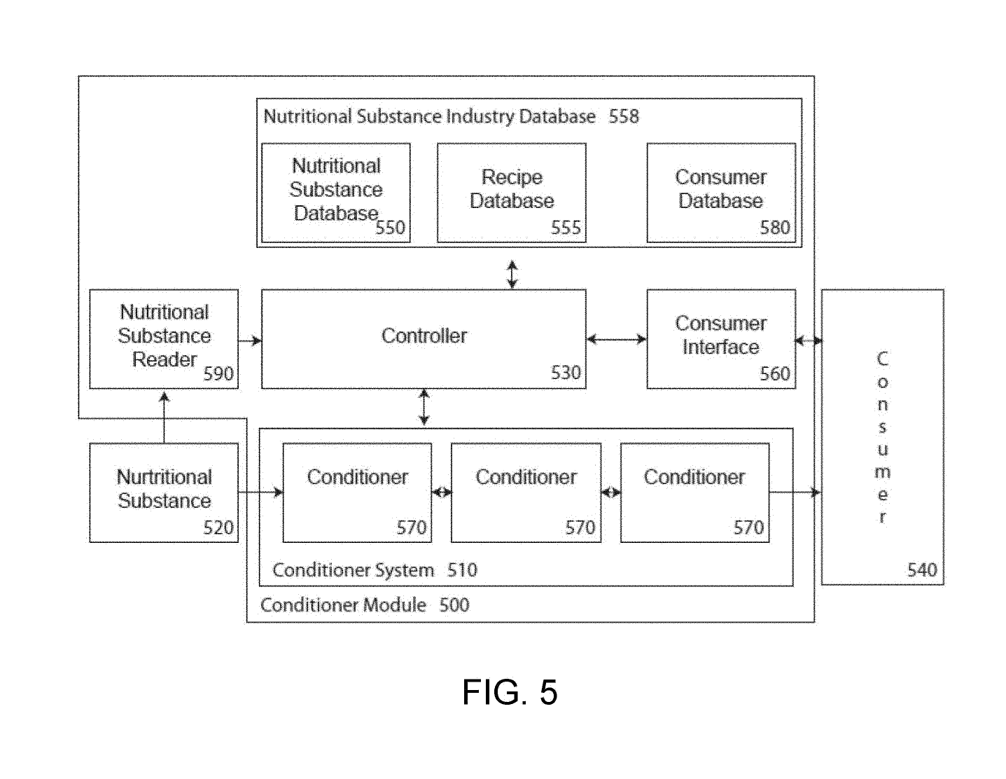

In FIG. 5, nutritional substance database 550, recipe database 555, and consumer database 580 are part of nutritional substance industry database 558. Controller 530 would communicate with nutritional substance industry database 558 through a communication system such as the internet, and preferably a telecommunications system such as wireless telecommunications. In such an arrangement, controller 530 could even verify that local supermarkets have the items in stock, retrieve and transmit a route to get to the supermarket from the consumer's current location, and further retrieve and transmit a route to follow within the supermarket to efficiently obtain the items.

In an embodiment of the present invention, a consumer wishing to condition a nutritional substance using a conditioning appliance according to the present invention can determine, and knowingly affect, the true residual nutritional, organoleptic, or aesthetic value of the nutritional substance after he puts it in the conditioning appliance. To do so, the consumer would scan a dynamic information identifier provided with the nutritional substance using a scanner provided with the conditioning appliance. This enables the conditioning appliance's controller to retrieve, from the nutritional substance industry database, information related to changes in nutritional, organoleptic, or aesthetic values (ΔN information) referenced to the dynamic information identifier. Thereafter, the conditioning appliance controller can request and receive input from the consumer by providing options for the consumer to choose from through a consumer interface, also referred to herein as a dynamic nutritional substance menu panel, which may be a panel, screen, keyboard, or any known type of user interface. The dynamic nutritional substance menu panel provides the consumer with the ability to input the desired end results for the residual nutritional, organoleptic, or aesthetic value that will remain after conditioning, such as by choosing among different possible end results offered by the dynamic nutritional substance menu panel. The controller then creates, or retrieves from the nutritional substance industry database, adaptive conditioning parameters that are responsive to: the ΔN information retrieved from the nutritional substance industry database using the dynamic information identifier; and the consumer input obtained through the dynamic nutritional substance menu panel. These adaptive conditioning parameters, also referred to herein as an adaptive preparation sequence, are then communicated to the consumer for implementation through the dynamic nutritional substance menu panel, or alternatively, automatically implemented by the controller.

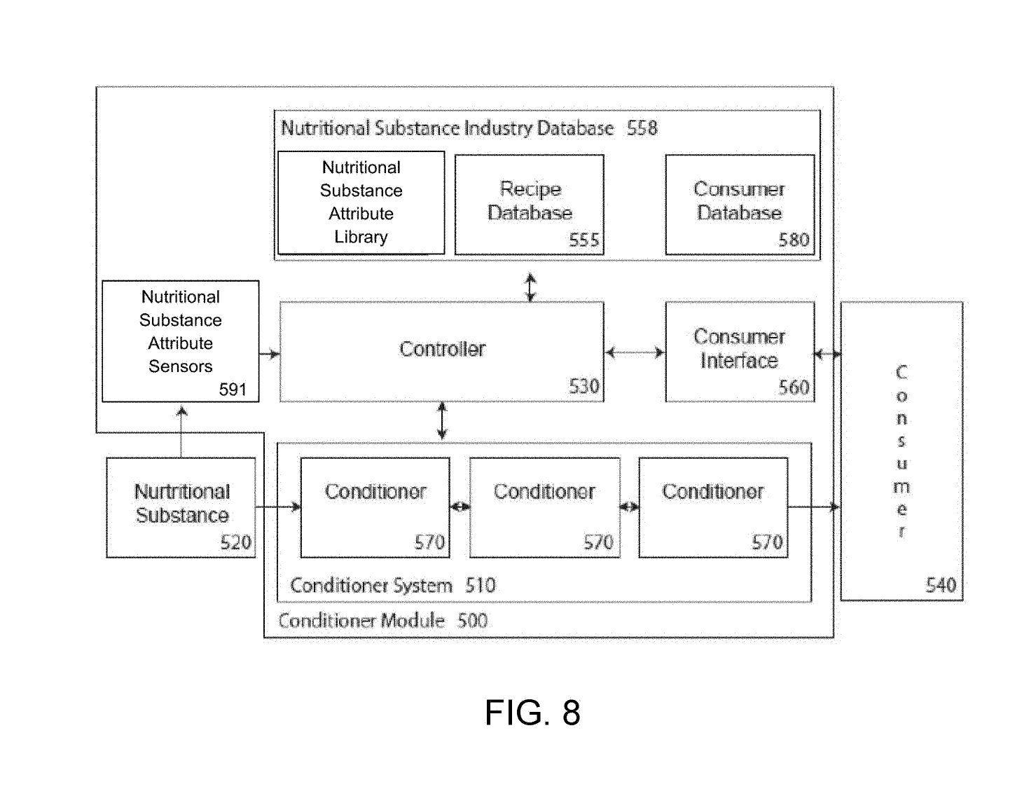

FIG. 8 shows an alternate embodiment of a conditioner module according to the present invention, wherein a conditioner, also referred to herein as a conditioning appliance, may have features enabling it to communicate with an alternate database that facilitates identification of a nutritional substance to be conditioned without the need for a dynamic information identifier. Such features may include, but are not limited to, sensors capable of measuring and collecting data regarding visual appearance, taste, smell, volatiles, texture, touch, sound, chemical composition, temperature, weight, volume, density, hardness, viscosity, surface tension, and any other known physical attribute of the nutritional substance, and are also referred to herein as nutritional substance attribute sensors. These may include, but are not limited to, optical sensors, laser sensors, cameras, electric noses, microphones, olfactory sensors, surface topography measurement equipment, three dimensional measuring equipment, chemical assays, hardness measuring equipment, ultrasound equipment, impedance detectors, temperature measuring equipment, weight measurement equipment, and any known sensor capable of providing data regarding a physical attribute of a nutritional substance. The alternate database would consist of a massive library of nutritional substance attribute data, related to the visual appearance, taste, smell, texture, touch, chemical composition and any other known physical attributes, referenced to corresponding nutritional, organoleptic, and aesthetic states of known nutritional substances, and is herein referred to as the nutritional substance attribute library.

At this juncture it can be understood that a nutritional, organoleptic or aesthetic value of a nutritional substance can be indicated by its olfactory values. Typically, but not necessarily, olfactory values are detectable by the human sense of smell. However, nutritional substance may emit or produce gaseous components that are not detectable or discernable by the human sense of smell but, nevertheless, may be indicative of particular nutritional, organoleptic, and aesthetic state of the nutritional substance. In addition, olfactory values can be indicative of contamination or adulteration of nutritional substances by other substances.

It is understood that the utilization of the nutritional substance attribute sensors according to the present invention can provide beneficial information regarding adulteration or mislabeling of nutritional substances.

In an example of a conditioning appliance equipped with nutritional substance attribute sensors, a consumer places a turkey breast in a combination microwave, convection, and grill oven equipped with nutritional substance attribute sensors. The nutritional substance attribute sensors collect a variety of physical attribute data from the turkey breast. The conditioning appliance's controller then transmits the physical attribute data collected to the nutritional substance industry database, for comparison to the nutritional substance attribute library contained therein. It is understood that while FIG. 8 shows the nutritional substance industry database as part of the conditioner module, it may reside in the information module. It is further understood that while the nutritional substance attribute library is shown as part of the nutritional substance industry database, this only for the purposes of example and not intended to be limiting in any way, and it may reside within the information module or may exist as an independent database. When a match is found for the physical attribute data collected from the turkey breast placed in the conditioning appliance, the nutritional substance industry database can determine that the matching nutritional substance attribute library dataset corresponds to a turkey breast with known nutritional, organoleptic, and aesthetic values, and that it weighs 2 pounds and is at a temperature of 40 deg. F. Thereafter, the conditioning appliance controller can request input from the consumer by providing options for the consumer to choose from through a consumer interface, also referred to herein as a dynamic nutritional substance menu panel, which may be a panel, screen, keyboard, or any known type of user interface. The dynamic nutritional substance menu panel provides the consumer with the ability to input the desired end results for the residual nutritional, organoleptic, or aesthetic value that will remain after conditioning, such as by choosing among different possible end results offered by the dynamic nutritional substance menu panel. The controller then creates, or retrieves from the nutritional substance industry database, adaptive conditioning parameters that are responsive to: the nutritional, organoleptic, and aesthetic value information retrieved from the nutritional substance industry database using the nutritional substance attribute library; and the consumer input obtained through the dynamic nutritional substance menu panel. These adaptive conditioning parameters, also referred to herein as adaptive preparation sequence, are then communicated to the consumer for implementation through the dynamic nutritional substance menu panel, or alternatively, automatically implemented by the controller.

Information and sensing capable conditioners may be provided in a variety of configurations known to those skilled in the art, and the examples offered herein are for purposed of illustration and not intended to be limiting in any way. In one example of an information and sensing capable conditioner, it is provided with traditional functionality, that is, it will interact with nutritional substances in a traditional fashion. However, the information and sensing capable conditioner is compatible with separately available controller 530 and nutritional substance attribute sensors 591, such that at any time during or after the manufacture and sale of the information and sensing capable conditioner, controller 530 and nutritional substance attribute sensors 591 may be coupled with the information and sensing capable conditioner to enable the full functionality and benefit of conditioner module 500. Information and sensing capable conditioners provide appliance manufacturers and consumers great flexibility, and will not become obsolete like dumb conditioners.

The coupling of controller 530 and nutritional attribute sensors 591 to the information and sensing capable conditioner may take any physical and/or communication format known to those skilled in the art. These may include, but are not limited to: an information and sensing capable conditioner provided with Bluetooth, or other wireless near-field communication capability, to communicate with a communication-compatible controller 530, wherein nutritional substance attribute sensors 591 are coupled with, or in communication with, controller 530. The controller 530 may be any of a completely separate unit, an externally attachable unit, and an internally placed unit, while portions of the nutritional substance attribute sensors may be positioned in proximity to, on, or within the conditioner 570, such as in ports or windows provided with the information and sensing capable conditioner; an information and sensing capable conditioner provided with a USB port, or other electrical communication capability, to communicate with a communication-compatible controller 530, wherein nutritional substance attribute sensors 591 are coupled with, or in communication with, controller 530. The controller 530 may be any of a completely separate unit, an externally attachable unit, and an internally placed unit, while portions of the nutritional substance attribute sensors may be positioned in proximity to, on, or within the information and sensing capable conditioner, such as in ports or windows provided with the information and sensing capable conditioner; an information and sensing capable conditioner provided with a fiber optic port, or other optical communication capability, to communicate with a communication-compatible controller 530, wherein nutritional substance attribute sensors 591 are coupled with, or in communication with, controller 530. The controller 530 may be any of a completely separate unit, an externally attachable unit, and an internally placed unit, while portions of the nutritional substance attribute sensors may be positioned in proximity to, on, or within the information and sensing capable conditioner, such as in ports or windows provided with the information and sensing capable conditioner; or an information and sensing capable conditioner provided with WiFi, or other wireless communication capability, to communicate with a WiFi compatible controller 530, wherein nutritional substance attribute sensors 591 are coupled with, or in communication with, controller 530. The controller 530 may be any of a completely separate unit, an externally attachable unit, and an internally placed unit, while portions of the nutritional substance attribute sensors may be positioned in proximity to, on, or within the conditioner 570, such as in ports or windows provided with the information and sensing capable conditioner. It is understood that the controller 530 may be provided with its own consumer interface, may communicate and be operated through the consumer interface provided with the information and sensing capable conditioner, or a combination of both.

It is understood that nutritional substance attribute sensors according to the present inventions, can beneficially be provided with, or combined with, other nutritional substance modules, including transformation, preservation, and consumer modules. For example, the nutritional substance attribute sensors could be provided with the local storage environments, containers, and coupons described herein. Nutritional substance attribute sensors, or at least a portion of the nutritional substance attribute sensor, could be provided with or incorporated into the package of any pre-packaged nutritional substance, such that a consumer may interrogate the package without disrupting its integrity to obtain information related to a nutritional, organoleptic, or aesthetic value of the nutritional substance contained therein. Further, nutritional substance attribute sensors, or at least a portion of the nutritional substance attribute sensor, could be provided with, coupled to, or incorporated into smartphones. This would enable a wide array of users and scenarios wherein nutritional substances can be identified and their current nutritional, organoleptic, and aesthetic state can be determined.

### Server Based & Hands Free Conditioning System

As discussed above, one key aspect of digital conditioning programs is the way the user interacts with the digital device that conveys the nutritional substance aesthetic, organoleptic and/or nutritional information, preparation instructions and actuation with the conditioner or appliance. Most traditional conditioning programs are displayed on a mobile device with touchscreens. As the user is preparing the food, there will be a need to interact with the device to change the page or screen to display subsequent instructions of the conditioning program after the instructions in the current page or screen have been followed. If the user is in the middle of the preparation their hands might not be free, and it will be necessary to stop preparation and clean their hands to move onto the next sets of instructions, which results in interruption of the preparation process. Likewise, if the user is using content such as video, or a set of videos, it might be necessary to pause the content to repeat instructions if the video is too fast, and if done using the touchscreen, the users are required to clean their hands to manipulate the content displayed. Furthermore, if the conditioning program is illustrated in a series of videos, the user will need to interrupt preparation to select and activate a subsequent video. A more challenging scenario for the user is when their hands are dirty and touch the display of the mobile device to manipulate the content of the digital conditioning program. In this case, the screen becomes dirty, which obstructs the view of the instructions and could also at least partially affect the touch capabilities of the device, or worst, damage the mobile device or expose consumers to biological contaminants. In this case, the user will have to clean his hands, and clean and dry the display of the device so it can be used to view the instructions of the conditioning program being followed. Of particular advantage, systems and methods of the present invention provide enhanced interface such that the user avoids the aforementioned limitations.

Furthermore, most conditioning systems store their instructions, conditioning protocols (if any) and user profile data locally on the memory serviced by the controller. However, this may not allow for coordination among multiple conditioners owned by the user, and easy replacement of the conditioner without a cumbersome memory transfer. Accordingly, in some instances, many of the conditioning protocols or portions thereof may be stored on a remote server. This allows the remote server to access a broader range of conditioning protocols, to update them, and to coordinate a conditioning protocol for a user between multiple conditioners. However, storing conditioning protocols and other instructions on a remote server brings many challenges, including that downloading of the conditioner protocol may be necessary so that during execution of the protocol, if internet access is lost or bandwidth restricted, the conditioner can continue conditioning.

Furthermore, conditioning protocols may need to be translated to accommodate different types of conditioning systems. For instance, two different ovens may emit different amounts of heat based on the same settings. Accordingly, in some examples, this system may translate conditioning protocols for particular ovens. For instance, this may include a translation protocol developed from a base conditioning protocol to increase or decrease the heating by some factor that may be known or refined through experience. For instance, if it is known that an oven is 130% hotter at medium than conventional or average ovens tested for the system, then the conditioning protocol sent to that particular oven may be first proportionally decreased to compensate by an appropriate factor. In other examples, if the oven is hotter at certain settings, the time could also be decreased at a certain step in a conditioning protocol. Accordingly, conditioning protocols may include a variety of steps at times, temperatures (or increasing temperature for certain amounts of times or to reach certain internal temperatures (of the oven cavity or a food temperature probe).

Similarly, the conditioning protocols may be customized for particular users as well. For instance, if the user prefers a less well done “medium” steak, the recipes may shorten the cooking time for the medium steak (e.g. the main cooking step in the middle). Therefore, for a particular user and a particular grill, the system may modify a conditioning protocol to compensate for differences in the grill heating (gas, electric, brand, model, or particular unit differences).

### Hands-Free Conditioning System

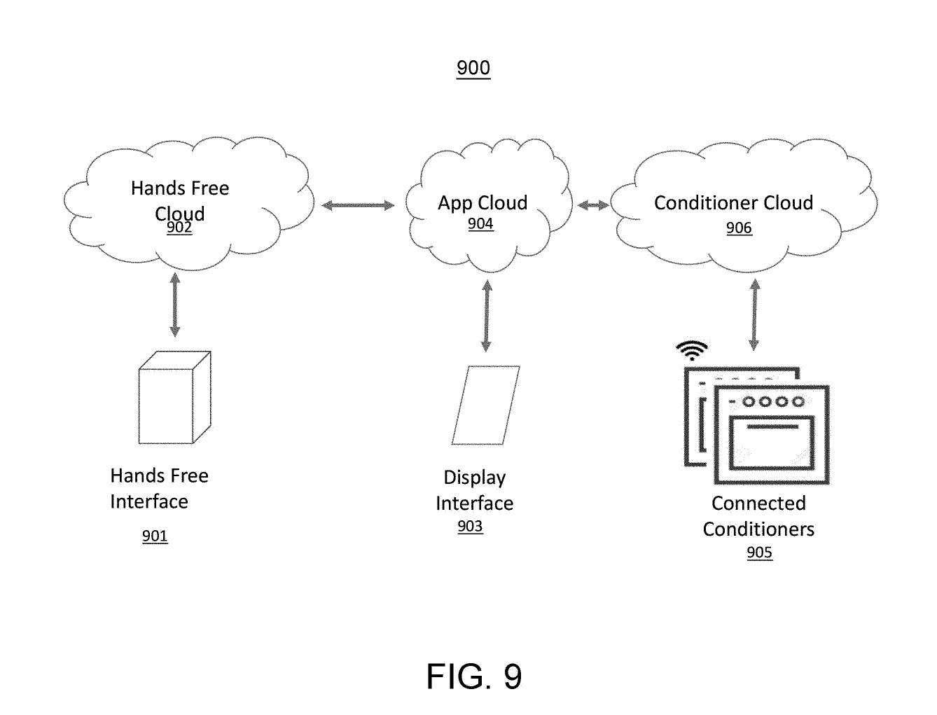

When an app in a mobile device is used by a consumer to receive conditioning program instructions, it is advantageous to navigate the app via hands-free means, to ensure efficient and effective control of the preparation and conditioning of the nutritional substance. FIG. 9 is a schematic diagram illustrating a broad architecture of the hands-free conditioning system 900 according to embodiments of the present invention. The hands-free conditioning system 900 is generally comprised of a hands-free interface device 901, coupled to a hands-free cloud 902, an application (app) cloud 904 coupled to a display interface 903, and a conditioner cloud 906 coupled to one or more conditioners 905. The App Cloud 904 contains a server linked to databases of conditioning protocols, which may be classified by type of conditioner, ingredients and further categorized into meal types (e.g. smoothies, pizzas, desserts, mains and sides) time of day (e.g. breakfast, lunch, dinner, snacks) and/or special occasions such as Eastern, Mother's Day, St Patrick's). In addition, the App Cloud 904 can also store the user profile with dietary preferences (e.g. vegetarian, paleo, pescatarian, vegetarian, vegan), food restrictions (kosher, gluten free and free or nuts or peanuts), user's cooking skill level and/or conditioners and tools the user owns or has access to.

More specifically, FIG. 9 illustrates the hands-free conditioning system 900, showing a hands-free interface 901 and its corresponding hands-free cloud 902, which in turns communicates with the app cloud 904 and display interface 903. The hands-free and display interfaces 901 and 903 provide the following information to or from the user: (a) nutritional substance information, such as the type, weight, creation date, expiration date, nutritional content and origin (b) conditioning status/alerts, (c) hands-free app navigation, including commands to move between screens or activate media, (d) specific organoleptic targets of the nutritional substance, (e) ratings/feedback for meal, (f) preparation time, based on the skill level of the user, and the like. Furthermore, when voice is utilized as the means for hands free navigation, the voice of the user can be identified via the hands-free interface in order to obtain user dietary preferences and/or restrictions to customize recipes and suggest recipes that are a close match to their profile.

In some examples, if voice is used to access recipes and user's profile in a conditioning app, the hands-free application needs to be trained to identify the voice of the user through voice biometrics. In other examples, the user may speak their name to retrieve their profile and preferences. For cases where the technology detects the user identity, the user's speech is digitized to produce a stored model voice print. The technology may break down the spoken work into segments comprising several dominant frequencies and tones that are captured in a digital format. In this example, the collective tones identify the user's unique voice print, which is stored in a remote or local database. Accordingly, this voice print may be utilized to identify which user audio data is associated with that is captured by a microphone.

The training of the hands-free interface can be done either through a pass phrase or code, or through individual voice pattern recognition. When pass phrases are used, the user recites some sort of text or pass phrase. The phrase may be repeated several times before the sample is analyzed and accepted as a template in the database. So, when the user speaks the assigned pass phrase, certain words are extracted and compared with the stored template for that individual. When a user attempts to gain access to the system, his or her pass phrase is compared with the previously stored voice model. Another approach is to train the hands-free interface to recognize similarities between the voice patterns of individuals when the user speaks unfamiliar phrases and the stored templates.

For instance, the user can speak to the voice hands-free interface to open a conditioning app by calling it out. Once the app is open, the user can speak his/her name to the hands-free interface so that the voice is recognized. In addition, the voice could also be used for authentication, such that the application will upload the user's profile with food preferences and dietary restrictions.

With the app open, the user can also call out an ingredient or a combination of ingredients to the hands-free interface. The ingredient or ingredients may be part of a shopping list, or ingredients that are available in the user's storage such as a refrigerator or a pantry. The system may then query a database (e.g. using a server to query a remote database of conditioning protocols) for conditioning protocols that match the list, and display the list of conditioning protocols on the display interface. In some examples the system may also provide an audio list of the conditioning protocols output through the speaker. The user can also request a list of conditioning protocols based on a specific diet, meals categories (time of day such as breakfast, lunch, dinner or snack or special occasions such as Thanksgiving, Christmas or Hanukah). As the conditioning protocols can be classified by the type of conditioner or appliance used, the system can filter out conditioning protocols based on the conditioner to which the user has access.

Once the user has decided which conditioning program to select, he/she can in turn send verbal instructions to the app to select a specific conditioning protocol. The microphone will then detect the audio input of the user and process the audio input to determine which conditioning protocol the user has selected. The display interface can then in turn show or call out the ingredients required to prepare the meal, nutritional information, conditioner type and tools, and preparation time based on the skill level of the user, step by step instructions amongst other type of information.

For instance, if the user calls out “Microwave Fish”, the App Cloud will select only those conditioning programs that require a microwave oven. Likewise, if the user calls out “Sous Vide Chicken”, the conditioning programs that can be “sous vide” will be selected.

Furthermore, if the user has access to one or more connected conditioner(s) 905 that are user to prepare the selected conditioning protocol, the corresponding conditioner cloud 906 interacting with the app cloud 904 and the conditioner(s) will receive conditioning instructions from the app cloud 904 and send those instructions to the connected conditioner 905. If a conditioning protocol requires two or more conditioners and the user has access to that specific connected conditioner 905, then the App Cloud 904 might need to send separate instructions for each connected conditioner 905. Additionally, the App Cloud 904 may coordinate the timing of each of the conditioning protocols, or send execution instructions at different times to each of the connected conditioners 905 so that both of the conditioners 905 finish conditioning at the appropriate times relative to each other (e.g. so that they finish at the same time). Moreover, the conditioners 905 may or may be not connected to the same Conditioner Cloud 906. If the conditioners 905 connect through different Conditioner Clouds 906, the App Cloud 904 will have to send the corresponding instructions to each separate Conditioner Cloud 906. Cloud to cloud interaction (App Cloud 904 to one or more Conditioner Cloud) is used to (a) determine conditioning parameters, (b) manage conditioning sessions, (c) register sensor information (d) and initiate and adapt the conditioning protocols according to sensor input (e.g. temperature, moisture, relative humidity, weight) and consumer input on desired organoleptic targets (e.g. medium well, well done) during the conditioning process, and the like. The adaptive conditioning protocols incorporate both sensor and consumer inputs to calculate an optimal sequence. The system then executes the adaptive conditioning protocols while measuring sensor variables related to the nutritional substance or conditioner. An example of execution of adaptive conditioning protocols on one or more conditioners is described in more detail in U.S. Pat. No. 9,702,858 the entire disclosure of which is hereby incorporated by reference.

Overall, the conditioning session information, including organoleptic status, is reported via the hands-free interface. Typically, the app cloud maintains state across multiple connected interfaces and conditioners. The app cloud orchestrates messages or notifications to users, gathers organoleptic and conditioning inputs, and manages the execution of the conditioning programs based on the state of the nutritional substance and/or conditioner (based on sensor input). In addition, the app clouds collect and analyze sensor data to monitor conditioning status against reference conditioning status stored in databases/algorithms to calculate appropriate changes to the conditioning protocols. The services are executed using a combination of cloud-based and/or local device-based information and logic. Each connected device may employ local storage or algorithms to supplement the cloud-based services.

Communication between a hands-free assistant device, such as a voice assistant enabled device, and the conditioning program application on a mobile device provides the user with the convenience of following and receiving instructions via voice, without having to touch the display of the mobile device. After the conditioning program application is configured and paired to a voice assistant device, the voice assistant can assist the user with the onboarding experience in the app, providing as much personal information as desired and specifying food preferences, specific diets, allergies and intolerances.

Once on-boarding is completed, which can be a one-time experience (or more if the user desires to add or update information), the user can use the voice assistant to select a meal of his choice, or to ask the assistant any recommendation based on user's profiles. The user will speak directly to the voice assistant device, which will provide a set of recommendations, to which the user can select one of the choices. If the meal selected has a potential conflict with the users' profile (for instance, presence of gluten on a profile with gluten intolerance), the assistant will warn the user and request to continue or to select another meal. Other filters could potentially be used, such as time of preparation, difficulty level or complexity, appliances required or nutritional content (carbohydrate or fat content) and ingredients (e.g. recipes that require hot peppers can be filtered out if desired).

If the user wishes to proceed with the meal, the assistant will confirm the meal selected and will, in communication with the app, display instructions for the meal, which can be broken down into two or more screens on multiple devices, or into one or more videos for visual illustration. For text instructions, the voice assistant can verbally provide instructions through its speaker(s).

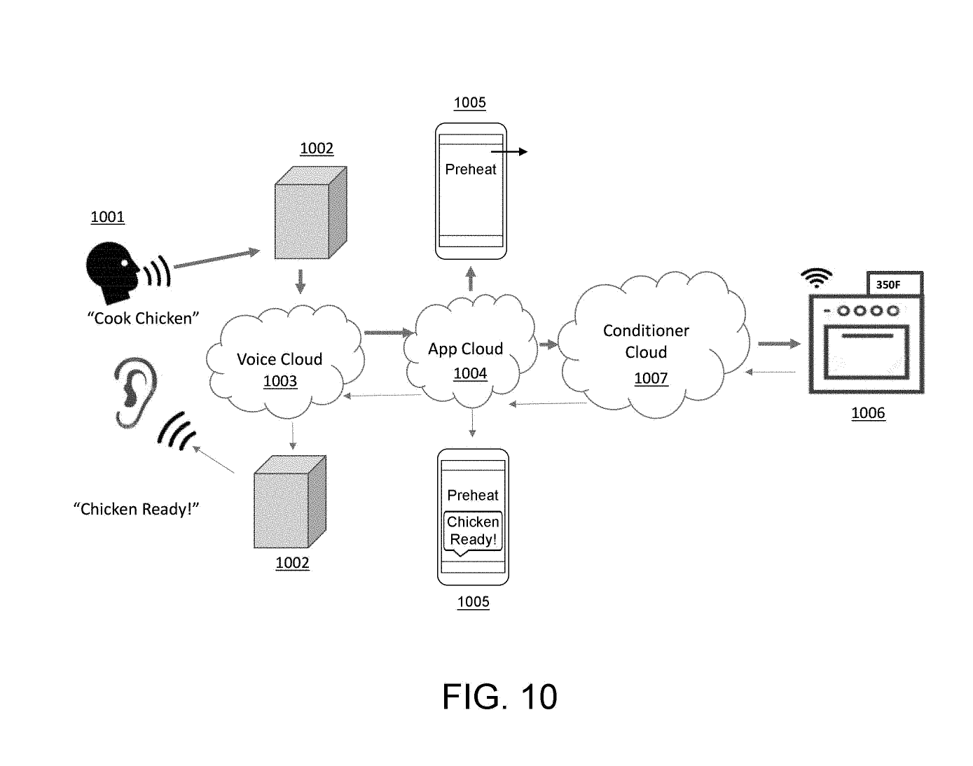

FIG. 10 is used to illustrate the hands-free control of a conditioner 1006 through the app running on a mobile device 1005 for conditioning programs and instructions that require connected conditioners. In this case, the user 1001 can command the voice assistant 1002 to activate the conditioner through the app. In that case, the system may process the audio data on a separate server and database comprising the voice cloud 1003. The app cloud 1003 has conditioner protocols with predetermined parameters for the conditioner control settings so the user 1001 does not have to dictate settings to the device assistant 1002. For instance, on the screen that lists the conditioning action of the conditioner, the user can command the voice assistant to “cook chicken”, without the need to specify oven settings or series of conditioning steps (e.g. convection bake at 350 F for 40 min, then broil for 5 min at 450 F), as the settings are specified in the conditioning protocol database stored in the app cloud 1004. In some examples, the app cloud will then communicate with the conditioner cloud 1007, which will send one or more conditioning sequences for the conditioner 1006 controller to execute. If the conditioning protocol is adaptive, the conditioner will automatically adjust the time, temperature or heating mode/power based on sensor input as the cook program executes. Once the conditioning process is completed, the voice assistant 1002 will verbally or audibly (e.g. through a beeping sound) indicate the user 1001 that the conditioning process is completed, and to move to the next steps, which could be to take the chicken out of the oven or continue other steps in the preparation of the meal.

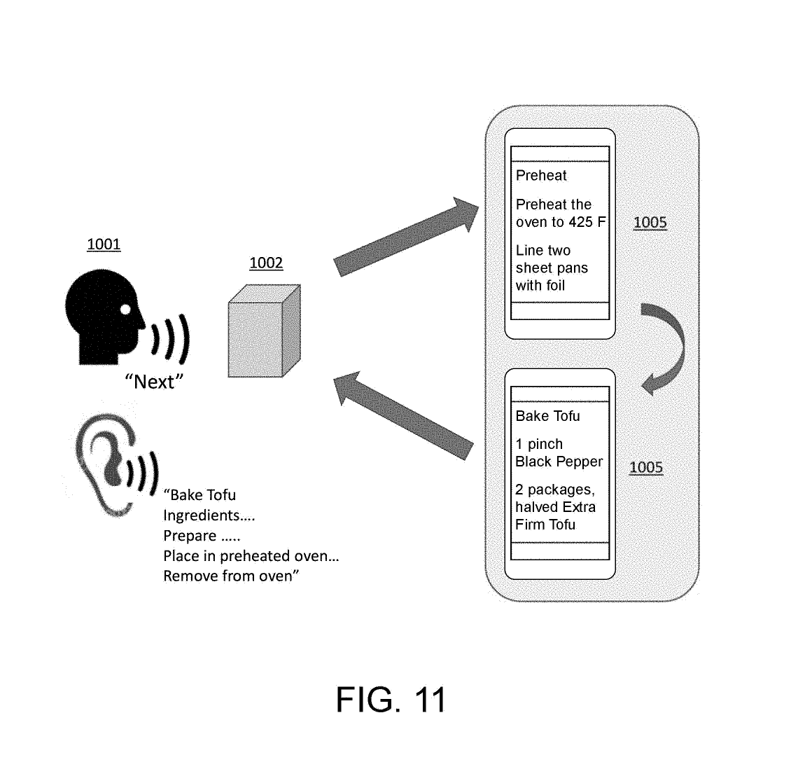

FIG. 11 illustrates hands-free navigation of the conditioning program made up of two or more screens with content and instructions, as displayed in the app of the mobile device. To move from one screen to subsequent screens, the user 1001 can verbally command the voice assistant 1002 to move screens in the app using the mobile device 1005. This is particularly useful when the users have tools and food items in their hands, so it allows to view the next screen without having to place down tools and food items and clean their hands to swipe with the fingers the display of the mobile device to move to the next screen or go back to the previous screens. The user can move to the next screen by sending the command “Next” to move forward one screen or “Back” to move back to the previous screen. Other commands that can be used are “Read instructions” for the voice assistant to read instructions to the users, or “Play Video” to play video on the display for visual illustration. Hands-free commands are also useful when the user 1001 has covered the conditioning program instructions in the app and wants to skip the rest, by using the command “Exit App”. In the case of multiple consumer interfaces or screens, user commands may result in update of status or content across multiple interfaces.

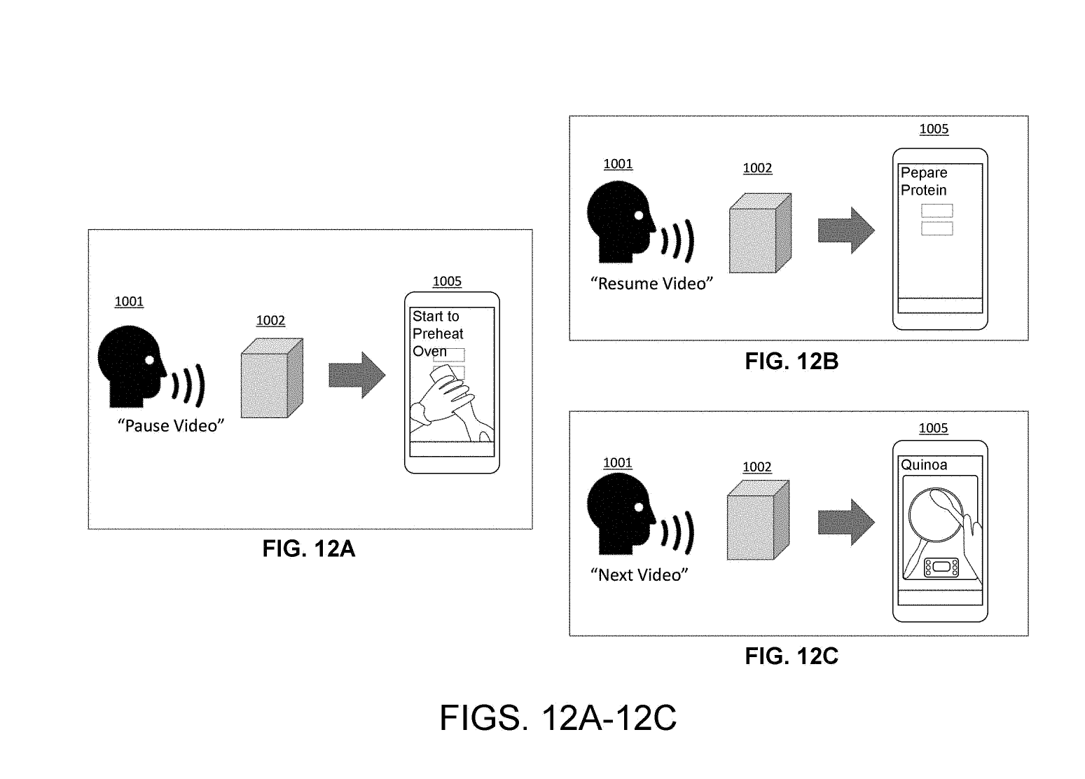

If users are relying on video to prepare the meal, they can send playback instructions to the voice assistant 1002 without the need to touch the display of the mobile device 1005. This feature is shown in FIGS. 12A-12C. For instance, whenever the user 1001 needs to pause or play back the video because it missed critical instructions of the preparation, the user can use the commands “Pause Video” with the voice assistant 1002 so that the video showing on the display of the mobile device pauses, as shown in FIG. 12A. The user 1001 can also use the commands “Rewind 3 sec” so that the video goes back 3 secs, and starts playing from that point. If the user 1001 decides to pause for any reason, the user can resume by commanding the voice assistant 1002 to “Resume” video as shown in FIG. 12B. If the user 1001 has finished viewing a given video or want to skip it, the user can move on to the next video by commanding “Next Video” to navigate to this specific video, as illustrated in FIG. 12C. Furthermore, the user 1001 can also move to the next text screen instead by commanding “Next Screen”. At the end of the meal preparation, the voice assistant can also request the user to rate the meal and voice any issues encountered or provide recommendations to further improve the meal preparation instructions, or any ingredients added to enhance the quality of the meal. The user can also indicate grocery items to be replenished or note that leftover recipes should be shown for the prepared nutritional substance in subsequent time periods.

### Methods for Voice Activated Based Conditioning Protocols

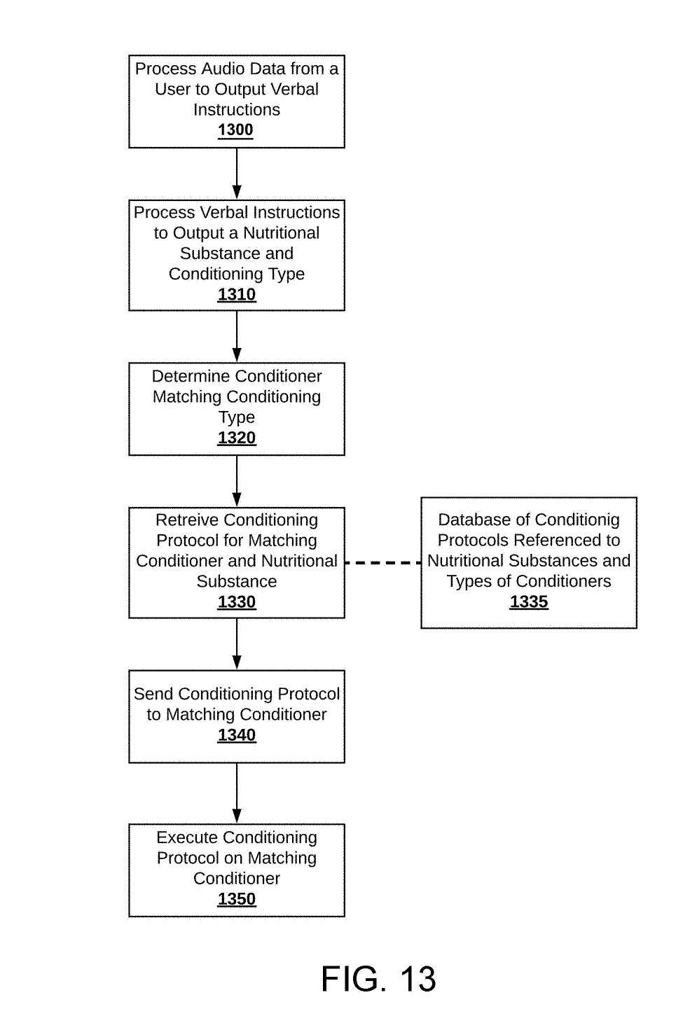

FIG. 13 illustrates an example of a method for implementing voice activated conditioning protocols. For instance, in some examples, the system will monitor the audio data output of a microphone for sounds of human voices. When a human voice is detected, the audio data may then be processed to output verbal instructions 1300. For instance, the voice data recorded by a microphone will be output as audio data, filtered, and sent for processing using machine learning and other voice recognition techniques to identify the verbal instructions 1300 included in the audio data. In some examples, the system may identify a word or phrase that indicates the user intended to convey instructions, rather than the microphone detecting the user(s) talking.

The verbal instructions may be processed by identifying whether any of the audio data relates to: (1) nutritional substances, (2) conditioning or cooking type, (3) conditioner or cooking device type, (4) types of ingredients, (5) styles of cooking (e.g. al dente), (6) specific dishes, or (7) other instructions that relate to conditioning nutritional substances according to various recipes in conditioners. Then, the matching instructions may be identified as the operative verbal instructions 1300 relating to cooking.

Particularly, the verbal instructions may be processed to output a conditioning type 1310. Then, the system may identify an available conditioner matching the conditioning type 1320 that is connected to the user's system. For instance, the system may identify a list of conditioners that are connected to the user's system (e.g. stored in a database connected to a remote server or stored locally and retrieved by a server) and determine which conditioners match based on the types of conditioners indicated in the verbal instructions. As used herein “conditioning type” or “type of conditioner” may include, but is not limited to, (1) brand of conditioners, (2) different models of the same brand of conditioners, or (3) category of conditioner (e.g. microwave, oven, food processor, grill, etc.). If the verbal instructions include “microwave” and the system is connected to a microwave (e.g. a profile of the user includes microwave as a list of available connected appliances) the system could proceed to retrieve conditioning protocols executable by microwaves. However, if the system is not connected to a microwave, the system may suggest alternatives or indicate it is not possible, for instance by audio feedback or feedback on a display or user interface.

Additionally, the verbal instructions may be processed to identify a nutritional substance the user would like to condition. In other examples, the system may automatically identify the substance using computer vision and rely on the voice activation for the conditioning protocol or cooking type. However, in the case where the nutritional substance is identified, the system may first identify parts of the verbal instructions that may relate to nutritional substances. Then, the algorithm may identify those parts relating to nutritional substances as an ingredient or a main or single nutritional substance to be conditioned based on the linguistic context.

Next, the system may retrieve a conditioning protocol or a list of conditioning protocols referenced to the matching conditioner and nutritional substance 1330. For instance, a remote server may process the nutritional substance and matching conditioner by querying a database of conditioning protocols referenced to nutritional substances and types of conditioners 1335. The database may store the conditioning protocols with reference to different types of categories including: (1) conditioner type, (2) conditioner model (e.g. brand of oven, and associated settings), (3) ingredient list, (4) dietary exclusions based on ingredients, (5) cooking difficulty level, (6) total conditioning time, (7) styles of cooking, (8) cuisine type (e.g. Italian, Vietnamese), and (9) and any other useful categories. Accordingly, the conditioning protocols may be queried with respect to these categories based on the user's verbal instructions.

Accordingly, the system may return a list of conditioning protocols for the user to select that match the desired or obtained nutritional substance and are compatible with the available conditioners for the particular user. In some examples, the conditioning protocols will be displayed as recipes for selection by the user on a user interface, or by voice activation of selection. For instance, the conditioning protocols may be displayed as 1, 2, 3, etc. and the user could indicate that they would like to select recipe “3,” which is oven roast chicken. Then, once the user has confirmed the conditioning protocol for execution by the conditioner, the server or system may send the conditioning protocol for download by the matching conditioner 1340 or the server may remotely execute the conditioning protocol and send instructions to the conditioner in real time. In other examples, the conditioner or local system connected to the user's conditioners may already contain preferred conditioning protocols and therefore they may be retrieved from local memory. In some examples, high level conditioning parameters may be sent to the connected conditioner, and the conditioner may translate the parameters into a conditioning protocol that may be executed by the controller of the connected conditioner. In other examples, the conditioner cloud, or other server and database may store conditioning protocols that are executable by the connected conditioner, and they may be sent or downloaded to the connected conditioner.

In some examples, the conditioning protocol selected may be translated for execution by the user's specific conditioner. This may happen in one single translation, or for each of the real time instructions sent to a connected conditioner. For instance, the input required for the API or other protocol translation service of the conditioner may require modifying the conditioning protocol. In some examples, experience of the user may illustrate that a particular conditioner is hotter than average conditioners for which the base or default conditioning protocols are intended to operate. In that case, all of the temperatures, modes, and/or durations of the conditioning protocol may be adjusted to accommodate. The particular settings or translation protocol for a given conditioner may be modified over time with quantitative or qualitative feedback from a user. For instance, the user's subject feedback may indicate one conditioner always overcooks meals and is therefore hotter than average based on the same settings. In this case, the remote server or conditioner cloud may automatically reduce the intensity or duration of heating for some or all of the steps for all conditioning protocols sent to that conditioner and/or initiated by a particular user. In some examples, the system may allow the user to calibrate the oven using a wireless item that can be inserted into the oven and record actual temperatures based on certain settings, including ramp up and heating times.

Next, the system executes the conditioning protocol on the matching conditioner 1350. In some examples, the local system or remote server may send instructions to initiate the conditioning protocol. In other examples, the system may wait for the user to initiate the conditioning on the specified conditioner to ensure the nutritional substance is inside the conditioner.

In some examples, the system may know the matching conditioner initially, because the user initiates the process on a particular smart conditioner, or the user may only have one smart conditioner in their home. In the case, the system only tries to identify the nutritional substance and other conditioning protocol preferences in the verbal instructions, but already has identified the conditioner.

The remote server and database that stores the conditioning protocols may also store profiles of each household and/or user, and customized versions of the conditioning protocols for the users. For instance, in some examples, certain conditioning protocols may be optimal for certain brands of ovens or types of ovens. In other examples, the user may have indicated preferences or feedback that modifies certain parameters of the conditioning protocols.

In some examples, the system may also determine an identity of the user by asking the user their name, or by detecting a quality of the audio data that is unique to the user. The system may include a calibration function to identify the voice of each particular user, and link the user's voice to the user's profile, that includes the user's preferences for conditioning, their allergies, and other unique features. In other examples, a user interface may store the preferences, conditioners available, and other profile data of a household rather than by individual users.

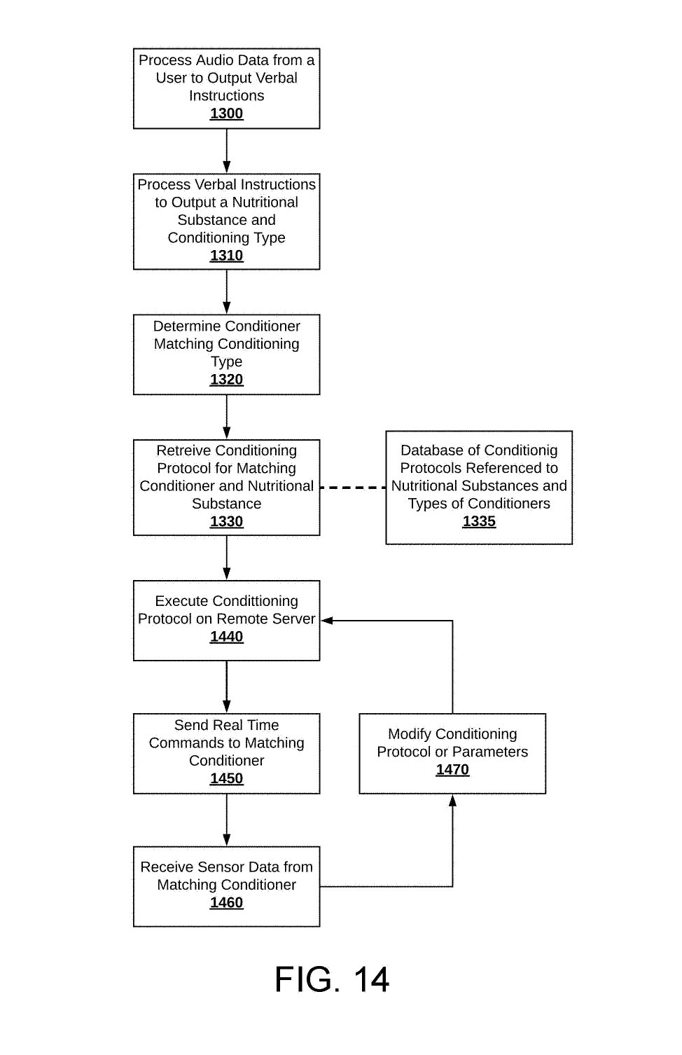

FIG. 14 illustrates another embodiment of the present disclosure that utilizes a remote server to control the matching conditioner rather than downloading the conditioning protocol directly to a conditioner. After the selected conditioning protocol is retrieved, 1330, the system may execute the conditioning protocol on a server remote from the oven, or separated from the conditioner by a network. Accordingly, the server may, during execution of the conditioning protocol, send real time commands to the conditioner 1450. These may include commands that include initiating conditioning, setting parameters for conditioning including conditioning mode (e.g. Bake and Temperature). In some examples, these parameters will be translated as appropriate for the particular conditioner (either initially or in real time).

These setting parameters will depend on the oven selected. Accordingly, as mentioned above, prior to executing the conditioning protocol, or during execution, the parameters and commands sent to the matching conditioner will be translated to match the settings of the particular conditioner. In some examples, a reference or mapping database may include conditioner settings and relative mappings to each conditioner connected to the server or algorithms for translation of protocols for each conditioner. For instance, bake 400 on the generic conditioning protocol may translate to broil 325 on a certain conditioner, and bake 350 on another conditioner. Additionally, the oven cavity size of each conditioner may be utilized to automatically adjust the conditioning protocols for a particular oven, including time and duration of the steps of a conditioning protocol.

During conditioning, the conditioning protocol will generally include a series of steps that include pre-heating (in some cases), main cooking, browning, or other types of conditioning steps. The remote server will keep track of the cooking time and send instructions to the matching conditioner at the appropriate times. For instance, during a first phase, the remote serve may send a command to the conditioner (or to another server that operates the conditioner, for instance that is operated by a different appliance company) to initiate cooking at a certain temperature and using a certain mode. The server will then record the elapsed time during this first phase of cooking, and at the appropriate time, send a second command to initiate a second phase of cooking with new parameters. In some cases, the cooking may include continually changing parameters and the server could send updates every minute, 30 seconds, 10 seconds, 5 minutes or other suitable interval to result in a more complex conditioner protocol.

This method is very advantageous, because many types ovens that may be controlled or receive control parameters through an internet connection do not have the ability to divide the cooking program into steps. Thus, providing the instructions remotely allows for more complex cooking programs regardless of the oven's settings, especially those that include complex steps and phases. This allows maximum compatibility, so all of the stored conditioning protocols may be utilized to control any number of conditioners that have a network connection and may receive control parameters through the connection, even if the conditioning protocols have complex and dynamic steps.

Additionally, the remote server may receive sensor data from the matching conditioner 1460. For instance, the matching conditioner may have ports that output sensor data sensed inside the conditioner that can be sent over a network and routed to the remote server. This can be utilized to modify conditioning parameters 1470 or modify the conditioning protocol if necessary. In some examples, the duration of steps, heating amount, or mode could be modified based on feedback. The sensors may include temperature sensors sending the oven cavity temperature, voltage levels of heating elements, probe temperature, humidity, and image sensors that detect aspects of the food. Accordingly, the remote server based control provides a completely integrated and complex control system for implementing a dynamic conditioning protocol.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. § 112, sixth paragraph, other aspects may likewise be embodied as a means-plus-function claim, or in other forms, such as being embodied in a computer-readable medium. Any claims intended to be treated under 35 U.S.C. § 112, ¶6 will begin with the words “means for.” Accordingly, the applicant reserves the right to add additional claims after filing the application to pursue such additional claim forms for other aspects of the invention.

1. A conditioning system for preparation and conditioning of nutritional substances comprising:
a microphone configured to output a set of audio data representative of a user's voice;
at least two types of conditioners;
a memory containing machine readable medium comprising machine executable code having stored thereon instructions;
a control system coupled to the memory comprising one or more processors, the control system configured to execute the machine executable code to cause the control system to:
process the set of audio data to output a set of verbal instructions;
process the set of verbal instructions to determine a nutritional substance and a conditioning type;
identify a matching conditioner based on the conditioning type of the at least two types of conditioners;
retrieving a matching conditioning protocol based on the matching conditioner from a database of conditioning protocols referenced to nutritional substances and different types of conditioners; and
sending instructions to the matching conditioner to initiate conditioning of the nutritional substance with the matching conditioning protocol.

2. The conditioning system of claim 1, wherein process the set of verbal instructions further comprises determine an identity of a the user.

3. The conditioning system of claim 2, wherein determining an identity of the user is determined based on unique qualities of the audio data associated with the user.

4. The conditioning system of claim 1, wherein the database is stored in communication with a server remote from the matching conditioner.

5. The conditioning system of claim 4, wherein the matching conditioning protocol is referenced to the user in the database and is customized based on the user's feedback.

6. The conditioning system of claim 4, further comprising a user profile stored in the database that includes conditioning preferences of the user.

7. The conditioning system of claim 1, wherein the at least two types of conditioners include a microwave and an oven.

8. A conditioning system for preparation and conditioning of nutritional substances comprising:
a microphone configured to output audio data representative of a user's voice;
at least one conditioner;
a memory containing machine readable medium comprising machine executable code having stored thereon instructions;
a control system coupled to the memory comprising one or more processors, the control system configured to execute the machine executable code to cause the control system to:
process a first set of audio data output from the microphone to output a set of verbal instructions;
process the set of verbal instructions to determine a nutritional substance;
retrieving a set of conditioning protocols based on the at least one conditioner and the nutritional substance from a database of conditioning protocols referenced to nutritional substances and different types of conditioners;
process a second set of audio data output from the microphone to output a confirmation of a user's selected conditioning protocol of the retrieved set of conditioning protocols;
execute the selected conditioning protocol; and
send instructions to the conditioner in real time during execution of the selected conditioning protocol to condition the nutritional substance.

9. A conditioning system for preparation and conditioning of nutritional substances comprising:
a user interface;
at least two conditioners;
a server in communication with the least one conditioner over a network connection;
a memory containing machine readable medium comprising machine executable code having stored thereon instructions;
a control system coupled to the memory comprising one or more processors, the control system configured to execute the machine executable code to cause the control system to:
determine by the server, a selected conditioner of the at least two conditioners and a selected nutritional substance based on a first set of data received from the user interface;
retrieve, by a server from a database, a set of conditioning protocols based on the selected conditioner and the selected nutritional substance from a database of conditioning protocols referenced to nutritional substances and different types of conditioners;
determine, by the server, a selected conditioning protocol of the retrieved set of conditioning protocols based on a second set of data received from the user interface;
initiate, by the server, a first step of the selected conditioning protocol by sending a first set of real time instructions to set parameters on the selected conditioner during conditioning for a first phase over the network; and
determine, by the server, when a duration of the first step has expired and send a second set of real time instructions to set parameters on the selected conditioner for a second phase over the network.

10. The conditioning system of claim 9, wherein sending the first and second set of real time instructions first comprises translating the instructions to be compatible with the selected conditioner.

11. The conditioning system of claim 9, wherein sending the first and second set of real time instructions first comprises modifying the instructions to be compensate for differences in settings of the selected conditioner in comparison to an average conditioner based on testing of the selected conditioning protocol.

12. The conditioning system of claim 11, wherein modifying the instructions comprises modifying a temperature, duration, or mode setting.

13. The conditioning system of claim 9, wherein the server receives sensor data output from at least one sensor connected to the selected conditioner in real time during conditioning and modifies the selected conditioning protocol based on the received sensor data in real time.
